(19) United States
(12) Patent Application Publication
(10) Pub. No.: US 2026/0122590 A1
(43) Pub. Date: Apr. 30, 2026

(54) CELL SYNCHRONIZATION METHOD, APPARATUS, DEVICE, AND STORAGE MEDIUM

(71) Applicant: HUAWEI TECHNOLOGIES CO., LTD., Shenzhen (CN)

(72) Inventors: Ting Wang, Shanghai (CN); Hao Tang, Shanghai (CN); Dongdong Wei, Shenzhen (CN); Jianglei Ma, Ottawa (CA)

(21) Appl. No.: 19/430,690

(22) Filed: Dec. 23, 2025

Related U.S. Application Data
(63) Continuation of application No. PCT/CN2023/103444, filed on Jun. 28, 2023.

(51) Int. Cl. H04W 56/00

(52) U.S. Cl. CPC H04W 56/001

(57) ABSTRACT

A cell synchronization method, an apparatus, a device, and a storage medium are provided. The method includes: determining first information, where the first information includes first synchronization information, the first synchronization information is used by a first communication device to perform cell synchronization, second synchronization information in the first synchronization information is used by a second communication device to perform cell synchronization, and a type of the first communication device is different from a type of the second communication device. A first apparatus sends the first information. After sending the first synchronization information to the first communication device, the first apparatus does not separately send the second synchronization information to the second communication device. This reduces signaling overheads during cell synchronization, and further improves communication performance.

### CROSS-REFERENCE TO RELATED APPLICATIONS

This application is a continuation of International Application No. PCT/CN2023/103444, filed on Jun. 28, 2023, the disclosure of which is hereby incorporated by reference in its entirety.

### TECHNICAL FIELD

This application relates to communication technologies, and in particular, to a cell synchronization method, an apparatus, a device, and a storage medium.

### BACKGROUND

In some communication systems, for example, a 5th generation (5G) mobile communication system, a plurality of different communication services may be implemented, for example, an enhanced mobile broadband (eMBB) service and a narrowband internet of things (NB-IoT). Devices that perform communication in different communication service scenarios may be different types of communication devices.

Currently, the communication device may perform cell synchronization based on synchronization information. Bandwidths occupied by synchronization information used by devices that perform communication in different communication service scenarios, or in other words, used by different types of communication devices, are different. For example, in an eMBB scenario, the synchronization information occupies 20 resource blocks (RBs), and in an NB-IoT scenario, the synchronization information occupies one RB or six RBs.

Therefore, different types of communication devices in the communication system need to perform cell synchronization based on respective synchronization information. Consequently, signaling overheads are high during cell synchronization, and communication performance is affected.

### SUMMARY

Embodiments of this application provide a cell synchronization method, a device, and a storage medium, to reduce signaling overheads during cell synchronization and improve communication performance.

According to a first aspect, an embodiment of this application provides a cell synchronization method. The method may be performed by a first apparatus. The first apparatus may be implemented as a communication device or a component (for example, a chip or a chip system) in a communication device. The communication device may be a network device or a terminal device. For ease of description, the following uses the first apparatus as an execution body for description.

The method includes: The first apparatus determines first information, where the first information includes first synchronization information, the first synchronization information is used by a first communication device to perform cell synchronization, second synchronization information in the first synchronization information is used by a second communication device to perform cell synchronization, and a type of the first communication device is different from a type of the second communication device. The first apparatus sends the first information. Because the first synchronization information includes the second synchronization information, cell synchronization of the first communication device can be implemented by using the first synchronization information, and cell synchronization of the second communication device can be implemented by using the second synchronization information in the first synchronization information. This reduces signaling overheads during cell synchronization, and improves communication performance.

It should be noted that for ease of understanding, only two different types of communication devices are used as an example for description in this application, but a number of types of communication devices that perform cell synchronization and that can be indicated by the first information is not limited. When the first information can be used by three or more types of communication devices to perform cell synchronization, more sub-information may be nested in the first synchronization information. For example, third synchronization information in the second synchronization information is used by a third communication device to perform cell synchronization. A type of the third communication device is different from the type of the first communication device, and the type of the third communication device is different from the type of the second communication device.

In a possible implementation, there may be a nested relationship between a first time-frequency resource carrying the first synchronization information and a second time-frequency resource carrying the second synchronization information. For example, the first time-frequency resource includes the second time-frequency resource. Therefore, communication resources are saved, and the communication performance is improved.

For example, the nested relationship between the first time-frequency resource and the second time-frequency resource may include: A frequency domain resource of the first time-frequency resource includes a frequency domain resource of the second time-frequency resource, and a time domain resource of the first time-frequency resource is the same as a time domain resource of the second time-frequency resource.

According to the possible implementation, synchronization information sent by the first apparatus occupies only the first time-frequency resource, and the first time-frequency resource includes the second time-frequency resource, so that synchronization of the first communication device and synchronization of the second communication device can be implemented. This reduces resources occupied by the synchronization information, reduces resource overheads, and improves the communication performance.

For example, the first synchronization information includes a first bit sequence, the second synchronization information includes a second bit sequence, and the first bit sequence includes the second bit sequence. A nested relationship between the first bit sequence and the second bit sequence reduces the signaling overheads during cell synchronization.

For example, the first synchronization information includes a first primary synchronization signal and/or a first secondary synchronization signal, and the second synchronization information includes a second primary synchronization signal and/or a second secondary synchronization signal. In this case, that the first synchronization information includes the second synchronization information may be that the first primary synchronization signal includes the second primary synchronization signal, and/or the first secondary synchronization signal includes the second secondary synchronization signal; or certainly, may be that the first primary synchronization signal includes the second secondary synchronization signal, and/or the first secondary synchronization signal includes the second primary synchronization signal; or may be that the first primary synchronization signal includes the second primary synchronization signal and/or the second secondary synchronization signal, or the first secondary synchronization signal includes the second primary synchronization signal and/or the second secondary synchronization signal. This implements flexible nesting between information, for applicability to more communication service scenarios.

In a first implementation, the first information may further include first broadcast information, the first broadcast information is used by the first communication device to perform cell synchronization, and second broadcast information in the first broadcast information is used by the second communication device to perform cell synchronization. There is a nested relationship between the first broadcast information and the second broadcast information, which can further reduce the signaling overheads during cell synchronization and improve the communication performance.

To further save communication resources, there may also be a nested relationship between a third time-frequency resource carrying the first broadcast information and a fourth time-frequency resource carrying the second broadcast information. For example, the third time-frequency resource includes the fourth time-frequency resource.

For example, that the first broadcast information includes the second broadcast information may be implemented as follows: A third bit sequence in the first broadcast information includes a fourth bit sequence in the second broadcast information.

For example, a part of the fourth bit sequence includes common information of the first communication device and the second communication device. In this case, the common information included in the part of the fourth bit sequence may be used by the first communication device and the second communication device to perform cell synchronization, and the common information does not need to be separately sent for each different type of communication device. Therefore, the signaling overheads are reduced.

In a second implementation, the first information further includes broadcast information, and the broadcast information is used by the first communication device and the second communication device to perform cell synchronization. The broadcast information is carried on a fourth time-frequency resource. A resource other than the fourth time-frequency resource in a third time-frequency resource is used to repeatedly transmit the broadcast information. Repeated transmission of the broadcast information can improve communication coverage of the broadcast information, improving communication reliability.

For example, the nested relationship between the third time-frequency resource and the fourth time-frequency resource may be implemented in the following three manners: Manner 1 is frequency domain nesting. For example, a frequency domain resource of the third time-frequency resource includes a frequency domain resource of the fourth time-frequency resource, and a time domain resource of the third time-frequency resource is the same as a time domain resource of the fourth time-frequency resource. Manner 2 is time-frequency domain nesting. For example, a frequency domain resource of the third time-frequency resource includes a frequency domain resource of the fourth time-frequency resource, and a time domain resource of the third time-frequency resource includes a time domain resource of the fourth time-frequency resource. Manner 3 is time domain nesting. For example, a frequency domain resource of the third time-frequency resource is the same as a frequency domain resource of the fourth time-frequency resource, and a time domain resource of the third time-frequency resource includes a time domain resource of the fourth time-frequency resource.

According to the possible implementation, the third time-frequency resource and the fourth time-frequency resource of the broadcast information sent by the first apparatus are nested. For example, the third time-frequency resource includes the fourth time-frequency resource. The first apparatus only needs to send the broadcast information on the third time-frequency resource, to implement synchronization of the first communication device and synchronization of the second communication device. This reduces resources occupied by the broadcast information, reduces the resource overheads, and improves the communication performance.

In a possible implementation, to reduce communication complexity of a transmit end and a receive end, a time-frequency resource (for example, the third time-frequency resource and the fourth time-frequency resource) carrying the broadcast information is in one-to-one correspondence with a time-frequency resource (for example, the first time-frequency resource and the second time-frequency resource) carrying the synchronization information. For example, when the frequency domain resource of the third time-frequency resource includes the frequency domain resource of the fourth time-frequency resource, the frequency domain resource of the third time-frequency resource is the same as the frequency domain resource of the first time-frequency resource, the frequency domain resource of the fourth time-frequency resource is the same as the frequency domain resource of the second time-frequency resource, the first time-frequency resource is used to carry the first synchronization information, and the second time-frequency resource is used to carry the second synchronization information.

To further reduce the signaling overheads during cell synchronization, transmission cycles of synchronization information and/or broadcast information corresponding to different types of communication devices may be different. For example, a transmission cycle of second information is different from a transmission cycle of third information in the first information. The second information includes the first synchronization information and/or the first broadcast information. The third information includes the second synchronization information and/or the second broadcast information.

For example, the transmission cycle of the second information is longer than the transmission cycle of the third information. It should be understood that the second information occupies more time-frequency resources than the first information, so that setting a long transmission cycle for the second information can reduce the resource overheads while ensuring cell synchronization efficiency.

For example, the first apparatus may send configuration information, where the configuration information indicates the transmission cycle of the second information and/or the transmission cycle of the third information, to implement flexible configuration of the transmission cycle of the information.

It may be understood that the broadcast information further includes indication information indicating a time-frequency resource used by a communication device for communication. A time-frequency resource that is indicated by indication information in the first broadcast information and that is used by the first communication device for communication may be a fifth time-frequency resource. A time-frequency resource that is indicated by indication information in the second broadcast information and that is used by the second communication device for communication may be a sixth time-frequency resource.

To further reduce the signaling overheads during cell synchronization, there may be a nested relationship between the fifth time-frequency resource and the sixth time-frequency resource. For example, the fifth time-frequency resource includes the sixth time-frequency resource.

For example, that the fifth time-frequency resource includes the sixth time-frequency resource may be specifically implemented as follows: A frequency domain resource of the fifth time-frequency resource includes a frequency domain resource of the sixth time-frequency resource, and a time domain resource of the fifth time-frequency resource is the same as a time domain resource of the sixth time-frequency resource. Alternatively, a frequency domain resource of the fifth time-frequency resource includes a frequency domain resource of the sixth time-frequency resource, and a time domain resource of the fifth time-frequency resource includes a time domain resource of the sixth time-frequency resource. Alternatively, a frequency domain resource of the fifth time-frequency resource is the same as a frequency domain resource of the sixth time-frequency resource, and a time domain resource of the fifth time-frequency resource includes a time domain resource of the sixth time-frequency resource.

According to the possible implementation, the fifth time-frequency resource and the sixth time-frequency resource are nested. For example, the fifth time-frequency resource includes the sixth time-frequency resource. The first apparatus only needs to communicate with the communication device on the third time-frequency resource, to implement communication with the first communication device and communication with the second communication device. This implements flexible resource sharing with different types of communication devices, improving resource utilization and improving the communication performance.

To reduce the communication complexity of the transmit end and the receive end, a time-frequency resource (for example, the fifth time-frequency resource and the sixth time-frequency resource) that carries an indication in the broadcast information and that is for communication is in one-to-one correspondence with the time-frequency resource (for example, the first time-frequency resource and the second time-frequency resource) carrying the synchronization information. For example, when the frequency domain resource of the fifth time-frequency resource includes the frequency domain resource of the sixth time-frequency resource, the frequency domain resource of the fifth time-frequency resource is the same as the frequency domain resource of the first time-frequency resource, the frequency domain resource of the sixth time-frequency resource is the same as the frequency domain resource of the second time-frequency resource, the first time-frequency resource is used to carry the first synchronization information, and the second time-frequency resource is used to carry the second synchronization information.

Optionally, the indication information indicates one of the following time-frequency resources: a control resource set CORESET 0 and an initial access bandwidth part (bandwidth part, BWP). Therefore, signaling overheads are reduced when the time-frequency resource used by the communication device for communication is indicated.

For example, a meaning of the indication information in the first broadcast information has a correspondence with the type of the first communication device, and/or a meaning of the indication information in the second broadcast information has a correspondence with the type of the second communication device. In this case, the meanings of the indication information in the broadcast information do not need to be distinguished for different types of communication devices, so that the communication complexity is reduced.

According to a second aspect, an embodiment of this application provides a cell synchronization method. The method may be performed by a second apparatus. The second apparatus may be implemented as a communication device or a component (for example, a chip or a chip system) in a communication device. The communication device is a first communication device or a second communication device. For ease of description, the following uses the second apparatus as an execution body for description.

The method includes: The second apparatus receives first information, where the first information includes first synchronization information, the first synchronization information is used by the first communication device to perform cell synchronization, second synchronization information in the first synchronization information is used by the second communication device to perform cell synchronization, and a type of the first communication device is different from a type of the second communication device; and performs cell synchronization based on the first information.

In a possible implementation, third synchronization information in the second synchronization information is used by a third communication device to perform cell synchronization. A type of the third communication device is different from the type of the first communication device. The type of the third communication device is different from the type of the second communication device.

In a possible implementation, the first synchronization information is carried on a first time-frequency resource, and the second synchronization information is carried on a second time-frequency resource. The first time-frequency resource includes the second time-frequency resource.

In a possible implementation, a frequency domain resource of the first time-frequency resource includes a frequency domain resource of the second time-frequency resource, and a time domain resource of the first time-frequency resource is the same as a time domain resource of the second time-frequency resource.

In a possible implementation, the first synchronization information includes a first bit sequence, and the second synchronization information includes a second bit sequence. The first bit sequence includes the second bit sequence.

In a possible implementation, the first synchronization information includes a first primary synchronization signal and/or a first secondary synchronization signal, and the second synchronization information includes a second primary synchronization signal and/or a second secondary synchronization signal.

In a possible implementation, the first information further includes first broadcast information. The first broadcast information is used by the first communication device to perform cell synchronization, and second broadcast information in the first broadcast information is used by the second communication device to perform cell synchronization.

In a possible implementation, the first broadcast information is carried on a third time-frequency resource, and the second broadcast information is carried on a fourth time-frequency resource. The third time-frequency resource includes the fourth time-frequency resource.

In a possible implementation, the first broadcast information includes a third bit sequence, and the second broadcast information includes a fourth bit sequence. The third bit sequence includes the fourth bit sequence.

In a possible implementation, a part of the fourth bit sequence includes common information of the first communication device and the second communication device.

In a possible implementation, the first information further includes broadcast information, and the broadcast information is used by the first communication device and the second communication device to perform cell synchronization. The broadcast information is carried on the fourth time-frequency resource. The receiving the first information includes: The second apparatus receives the broadcast information on the fourth time-frequency resource.

In a possible implementation, a type of the communication device corresponds to the third time-frequency resource, and a resource other than the fourth time-frequency resource in the third time-frequency resource is used to repeatedly transmit the broadcast information. The receiving the first information includes: The second apparatus receives the repeatedly transmitted broadcast information on the resource other than the fourth time-frequency resource in the third time-frequency resource.

In a possible implementation, a frequency domain resource of the third time-frequency resource includes a frequency domain resource of the fourth time-frequency resource, and a time domain resource of the third time-frequency resource is the same as a time domain resource of the fourth time-frequency resource, or a time domain resource of the third time-frequency resource includes a time domain resource of the fourth time-frequency resource. Alternatively, a frequency domain resource of the third time-frequency resource is the same as a frequency domain resource of the fourth time-frequency resource, and a time domain resource of the third time-frequency resource includes a time domain resource of the fourth time-frequency resource.

In a possible implementation, when the frequency domain resource of the third time-frequency resource includes the frequency domain resource of the fourth time-frequency resource, the frequency domain resource of the third time-frequency resource is the same as the frequency domain resource of the first time-frequency resource, the frequency domain resource of the fourth time-frequency resource is the same as the frequency domain resource of the second time-frequency resource, the first time-frequency resource is used to carry the first synchronization information, and the second time-frequency resource is used to carry the second synchronization information.

In a possible implementation, the broadcast information is carried on a physical broadcast channel (PBCH).

In a possible implementation, a transmission cycle of second information is different from a transmission cycle of third information in the first information. The second information includes the first synchronization information and/or the first broadcast information. The third information includes the second synchronization information and/or the second broadcast information.

In a possible implementation, the transmission cycle of the second information is longer than the transmission cycle of the third information.

In a possible implementation, the method further includes: The second apparatus sends configuration information, where the configuration information indicates the transmission cycle of the second information and/or the transmission cycle of the third information.

In a possible implementation, a fifth time-frequency resource includes a sixth time-frequency resource. The fifth time-frequency resource is a time-frequency resource that is indicated by indication information in the first broadcast information and that is used by the first communication device for communication. The sixth time-frequency resource is a time-frequency resource that is indicated by indication information in the second broadcast information and that is used by the second communication device for communication.

In a possible implementation, the fifth time-frequency resource includes the sixth time-frequency resource. A frequency domain resource of the fifth time-frequency resource includes a frequency domain resource of the sixth time-frequency resource, and a time domain resource of the fifth time-frequency resource is the same as a time domain resource of the sixth time-frequency resource, or a time domain resource of the fifth time-frequency resource includes a time domain resource of the sixth time-frequency resource. Alternatively, a frequency domain resource of the fifth time-frequency resource is the same as a frequency domain resource of the sixth time-frequency resource, and a time domain resource of the fifth time-frequency resource includes a time domain resource of the sixth time-frequency resource.

In a possible implementation, when the frequency domain resource of the fifth time-frequency resource includes the frequency domain resource of the sixth time-frequency resource, the frequency domain resource of the fifth time-frequency resource is the same as the frequency domain resource of the first time-frequency resource, the frequency domain resource of the sixth time-frequency resource is the same as the frequency domain resource of the second time-frequency resource, the first time-frequency resource is used to carry the first synchronization information, and the second time-frequency resource is used to carry the second synchronization information.

In a possible implementation, the indication information indicates one of the following time-frequency resources: a control resource set CORESET 0 and an initial access bandwidth part BWP.

In a possible implementation, a meaning of the indication information in the first broadcast information has a correspondence with the type of the first communication device, and/or a meaning of the indication information in the second broadcast information has a correspondence with the type of the second communication device.

For beneficial effects of the cell synchronization method provided in the second aspect and the possible implementations of the second aspect, refer to the beneficial effects brought by the first aspect and the possible implementations of the first aspect.

According to a third aspect, an embodiment of this application provides a communication apparatus. The communication apparatus may be a first apparatus, or may be a module or unit (for example, a chip, a chip system, or a circuit) in a first apparatus that is in one-to-one correspondence with the method/operation/action described in the first aspect and the possible implementations, or may be an apparatus that can be matched with a first apparatus for use. Alternatively, the communication apparatus may be a second apparatus, or may be a module or unit (for example, a chip, a chip system, or a circuit) in a second apparatus that is in one-to-one correspondence with the method/operation/action described in the second aspect and the possible implementations, or may be an apparatus that can be matched with a second apparatus for use.

For beneficial effects of the communication apparatus provided in the third aspect and the possible implementations of the third aspect, refer to the beneficial effects brought by the first aspect and the possible implementations of the first aspect.

According to a fourth aspect, an embodiment of this application provides a communication device, including a processor and a memory. The memory is configured to store a computer program. The processor is configured to invoke and run the computer program stored in the memory, to perform the method in the first aspect, the second aspect, or the possible implementations.

For beneficial effects of the communication device provided in the fourth aspect and the possible implementations of the fourth aspect, refer to the beneficial effects brought by the first aspect and the possible implementations of the first aspect.

According to a fifth aspect, an embodiment of this application provides a chip, including a processor, configured to invoke computer instructions from a memory and run the computer instructions, so that a device on which the chip is installed performs the method in the first aspect, the second aspect, or the possible implementations.

According to a seventh aspect, an embodiment of this application provides a computer-readable storage medium, configured to store computer program instructions. The computer program instructions enable a computer to perform the method in the first aspect, the second aspect, or the possible implementations.

According to an eighth aspect, an embodiment of this application provides a computer program product, including computer program instructions. The computer program instructions enable a computer to perform the method in the first aspect, the second aspect, or the possible implementations.

### BRIEF DESCRIPTION OF DRAWINGS

FIG. 1 is a diagram of an architecture of a communication system to which example embodiments of this application are applied;

FIG. 2 is a schematic flowchart of a cell synchronization method according to an example embodiment of this application;

FIG. 3 is a diagram of time-frequency resource nesting according to an example embodiment of this application;

FIG. 4a is a diagram of time-frequency resource nesting according to an example embodiment of this application;

FIG. 4b is a diagram of time-frequency resource nesting according to an example embodiment of this application;

FIG. 4c is a diagram of time-frequency resource nesting according to an example embodiment of this application;

FIG. 5a is a diagram of time-frequency resource nesting according to an example embodiment of this application;

FIG. 5b is a diagram of time-frequency resource nesting according to an example embodiment of this application;

FIG. 5c is a diagram of time-frequency resource nesting according to an example embodiment of this application;

FIG. 6 is a diagram of bit sequence nesting according to an example embodiment of this application;

FIG. 7 is a diagram of a transmission cycle according to an example embodiment of this application;

FIG. 8a is a diagram of time-frequency resource nesting according to an example embodiment of this application;

FIG. 8b is a diagram of time-frequency resource nesting according to an example embodiment of this application;

FIG. 8c is a diagram of time-frequency resource nesting according to an example embodiment of this application;

FIG. 9a is a diagram of time-frequency resource nesting according to an example embodiment of this application;

FIG. 9b is a diagram of time-frequency resource nesting according to an example embodiment of this application;

FIG. 9c is a diagram of time-frequency resource nesting according to an example embodiment of this application;

FIG. 10 is a diagram of a structure of a communication apparatus according to an example embodiment of this application; and

FIG. 11 is another schematic block diagram of a communication apparatus according to an example embodiment of this application.

### DESCRIPTION OF EMBODIMENTS

For ease of understanding embodiments of this application, a communication service scenario to which this application may be applied is first described with examples.

eMBB: further improves performance such as user experience based on an existing mobile broadband service scenario, is widely used in daily life application scenarios, and greatly improves a network speed, implementing large-traffic mobile broadband services for users.

Ultra-reliable and low-latency communication (URLLC): features high reliability, low latency, and extremely high availability. For example, ultra-reliable and low latency communication is widely applied to industrial application and control, traffic safety and control, remote manufacturing, remote training, and remote surgery. URLLC has great potential in a self driving service. The URLLC includes a communication service that requires a low-latency and highly-reliable connection, for example, the foregoing self driving and industrial automation services.

Machine type communication (MTC): is also referred to as M2M, and features low costs and enhanced coverage. Massive machine type communication (mMTC) in the MTC is a large-scale internet of things service.

NB-IoT: features wide coverage, numerous connections, a low rate, low costs, low power consumption, an excellent architecture, and the like, for example, massive connections, lower power consumption, and lower chip costs. For example, communication services between smart water meters, smart parking, smart pet tracking, smart bicycles, smart smoke detectors, smart toilets, and smart vending machines are all NB-IoT services.

Customer premises equipment (CPE): is a mobile signal access device that receives a mobile signal and forwards the mobile signal by using a Wi-Fi signal, is also a device that converts a high-speed 4G or 5G signal into a Wi-Fi signal, and may support a large number of mobile terminals in simultaneously accessing the Internet. The CPE can be widely used in rural areas, towns, hospitals, organizations, factories, residential units, and the like for wireless network access, to reduce costs of wired network deployment. Augmented reality (AR) or virtual reality (VR): is a virtual environment that is created by combining reality and virtuality by using a computer and in which human-computer interaction can be performed. Augmented reality or virtual reality has been widely used in various fields closely related to production and life of people, for example, education, entertainment, medical care, environmental protection, transportation, and public health.

Vehicle-to-everything (V2X): is a key technology of an intelligent transportation system. Through vehicle-to-everything, communication can be performed between vehicles, between a vehicle and a base station, and between base stations. In this way, a series of traffic information such as a real-time road condition, road information, and pedestrian information can be obtained. This improves driving safety, reduces congestion, improves traffic efficiency, provides in-vehicle infotainment information, and the like.

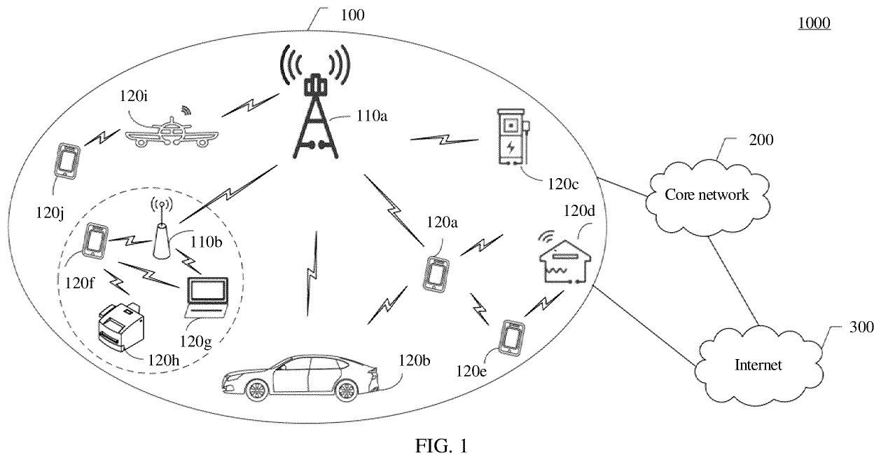

FIG. 1 is a diagram of an architecture of a communication system 1000 to which embodiments of this application are applied. As shown in FIG. 1, the communication system includes a radio access network 100 and a core network 200. Optionally, the communication system 1000 may further include an internet 300. The radio access network 100 may include at least one radio access network device (for example, 110a and 110b in FIG. 1), and may further include at least one terminal (for example, 120a to 120j in FIG. 1). The terminal is connected to the radio access network device in a wireless manner, and the radio access network device is connected to the core network in a wireless or wired manner. A core network device and the radio access network device may be independent and different physical devices, or functions of the core network device and logical functions of the radio access network device are integrated into a same physical device, or a part of functions of the core network device and a part of functions of the radio access network device are integrated into one physical device. A wired or wireless manner may be used for connection between terminals and between radio access network devices. FIG. 1 is merely a diagram. The communication system may further include another network device, for example, may further include a wireless relay device and a wireless backhaul device, which are not shown in FIG. 1.

The radio access network device is an access device used by the terminal to access the communication system in a wireless manner. The radio access network device may be a base station, an evolved base station (eNodeB), a transmission reception point (TRP), a next generation base station (next generation NodeB, gNB) in a 5th generation (5G) mobile communication system, a next generation base station in a 6th generation (6G) mobile communication system, a base station in a future mobile communication system, an access node in a Wi-Fi system, or the like; or may be a module or unit that completes a part of functions of a base station, for example, may be a central unit (CU), or may be a distributed unit (DU). The CU herein completes functions of a radio resource control protocol and a packet data convergence protocol (PDCP) of the base station, and may further complete functions of a service data adaptation protocol (SDAP). The DU completes functions of a radio link control layer and a medium access control (MAC) layer of the base station, and may further complete a part or all of functions of a physical layer. For specific descriptions of the foregoing protocol layers, refer to technical specifications related to the 3rd generation partnership project (3GPP). The radio access network device may be a macro base station (for example, 110a in FIG. 1), or may be a micro base station or an indoor base station (for example, 110b in FIG. 1), or may be a relay node or a donor node. A specific technology and a specific device form that are used by the radio access network device are not limited in embodiments of this application. For ease of description, the following provides descriptions by using an example in which the base station is used as the radio access network device.

The terminal is a device having a wireless transceiver function, and may send a signal to the base station, or receive a signal from the base station. The terminal may also be referred to as a terminal device, user equipment (UE), a mobile station, a mobile terminal, or the like. The terminal may be widely used in various communication service scenarios, for example, the foregoing communication service scenarios eMBB, URLLC, MTC, NB-IoT, CPE, AR, VR, and V2X. Based on the foregoing communication service scenarios, the terminal may be used in fields such as industrial control, self driving, telemedicine, a smart grid, smart furniture, a smart office, a smart wearable, smart transportation, and a smart city. The terminal may be a mobile phone, a tablet computer, a computer with a wireless transceiver function, a wearable device, a vehicle, an airplane, a ship, a robot, a robotic arm, a smart home device, or the like. A specific technology and a specific device form that are used by the terminal are not limited in embodiments of this application.

The base station and the terminal may be fixed or movable. The base station and the terminal may be deployed on land, including an indoor or outdoor device, a hand-held device, or a vehicle-mounted device; may be deployed on water; or may be deployed on an airplane, a balloon, or an artificial satellite. Application scenarios of the base station and the terminal are not limited in embodiments of this application.

Roles of the base station and the terminal may be relative. For example, a helicopter or uncrewed aerial vehicle 120i in FIG. 1 may be configured as a mobile base station. For the terminal 120j accessing the radio access network 100 via 120i, the terminal 120i is a base station. However, for the base station 110a, 120i is a terminal. In other words, communication between 110a and 120i is performed based on a radio air interface protocol. Certainly, communication between 110a and 120i may alternatively be performed based on an interface protocol between base stations. In this case, for 110a, 120i is also a base station. Therefore, both the base station and the terminal may be collectively referred to as communication devices, 110a and 110b each in FIG. 1 may be referred to as a communication device having a base station function, and 120a to 120j each in FIG. 1 may be referred to as a communication device having a terminal function.

Different communication devices may perform communication transmission in the foregoing communication service scenario. For example, a terminal may perform uplink transmission or downlink transmission with a base station in the communication service scenario. For example, the terminal 120a sends uplink information to the base station 110a. For another example, the base station 110a sends downlink information to the terminal device 120a. Alternatively, a terminal may perform sidelink transmission with a terminal in the communication service scenario. For example, the terminal 120a sends sidelink information to the terminal 120b. For another example, the terminal 120b sends sidelink information to the terminal 120a. Information transmission may also be performed between base stations in the communication service scenario. For example, the base station 110a sends information to the base station 110b, or the base station 110b sends information to the base station 110a.

Communication between a base station and a terminal, between base stations, or between terminals may be performed by using a licensed spectrum, may be performed by using an unlicensed spectrum, or may be performed by using both a licensed spectrum and an unlicensed spectrum. Communication may be performed by using a spectrum below 6 gigahertz (gigahertz, GHz), may be performed by using a spectrum above 6 GHz, or may be performed by using both a spectrum below 6 GHz and a spectrum above 6 GHz. A spectrum resource for wireless communication is not limited in embodiments of this application.

In embodiments of this application, a function of the base station may be performed by a module (for example, a chip) in the base station, or may be performed by a control subsystem including the function of the base station. The control subsystem including the function of the base station herein may be a control center in the foregoing application scenarios, such as a smart grid, industrial control, smart transportation, and a smart city. A function of the terminal may be performed by a module (for example, a chip or a modem) in the terminal, or may be performed by an apparatus including the function of the terminal.

In this application, the base station sends a downlink signal or downlink information to the terminal, where the downlink information is carried on a downlink channel; and the terminal sends an uplink signal or uplink information to the base station, where the uplink information is carried on an uplink channel. To communicate with the base station, the terminal needs to establish a wireless connection to a cell controlled by the base station. The cell that establishes the wireless connection to the terminal is referred to as a serving cell of the terminal. When communicating with the serving cell, the terminal is further interfered by a signal from a neighboring cell.

The communication system in this embodiment of this application may be applied to satellite communication. In a satellite communication scenario, the base station provides access and network services for the terminal, and a satellite serves as a forwarding unit to forward a signal between the terminal and the base station. The satellite communicates with the base station via a terrestrial station. The satellite, the terrestrial station, and the base station form a radio access network of a satellite communication system. In another satellite communication scenario, a satellite not only serves as a forwarding unit, but also can implement functions of the satellite and the base station and provide a radio access service for the terminal. The satellite may access a terrestrial core network via a terrestrial station.

In some embodiments, there is no communication link between satellites, and direct communication cannot be performed. In some other embodiments, there is an inter-satellite link between satellites for direct communication between the satellites.

The satellite may be an uncrewed aerial vehicle, a hot air balloon, a low Earth orbit satellite, a medium Earth orbit satellite, a high Earth orbit satellite, or the like. Alternatively, the satellite may be a non-terrestrial base station, a non-terrestrial device, or the like.

When the communication device in the communication system is used in different communication service scenarios, synchronization information for cell synchronization occupies different bandwidths. The NB-IoT and eMBB are used as an example. Synchronization information in the NB-IoT occupies a resource of one RB in frequency domain. The one RB occupied by the synchronization information in the NB-IoT is an RB resource that is independently configured in an entire bandwidth. In the NB-IoT scenario, the communication device may transmit the synchronization information on the resource of the one RB. Synchronization information in eMBB occupies 20 RBs in frequency domain. It can be learned that a transmission resource for the synchronization information in eMBB is incompatible with a transmission resource in the NB-IoT. In addition, there is a problem of incompatibility between synchronization information for users having different bandwidth requirements, that is, different types of communication devices, in different communication service scenarios. Therefore, transmission resources need to be allocated to synchronization information transmitted in different communication service scenarios, resulting in high overheads of the synchronization information, reducing communication performance.

For the foregoing technical problem, in embodiments of this application, information of different types of communication devices for cell synchronization is designed in a nested manner, that is, there is a nested relationship between information that is for cell synchronization and that corresponds to different types of communication devices, to reduce signaling overheads during cell synchronization and improve the communication performance.

For ease of understanding, the nested relationship between the information in this application is first described with an example.

The nested relationship between the information may be a nested relationship between bit sequences of the information and/or a nested relationship between time-frequency resources occupied by the information.

For example, a bit sequence of information A includes a 0^{th} bit to a 5^{th} bit of “011100”, and a bit sequence of information B includes the 1^{st} bit to the 4^{th} bit, that is, “1110”, in the bit sequence of the information A. It may be considered that there is a nested relationship between the bit sequence of the information A and the bit sequence of the information B. It should be noted that 0 to 5 in the 0^{th} bit to the 5^{th} bit may be understood as bit indexes. In this application, sequence numbers of the indexes are not limited, and are not limited to starting from 0. For example, the bit sequence “011100” of the information A may be described as a 1^{st} bit to a 6^{th} bit, and correspondingly, the bit sequence “1110” of the information B may be described as the 2^{nd} bit to the 5^{th} bit.

The nested relationship between the time-frequency resources may include a nested relationship between time domain resources and/or a nested relationship between frequency domain resources. For example, if a time domain start position of a time domain resource A occupied by the information A is earlier than a time domain start position of a time domain resource B occupied by the information B, and a time domain end position of the time domain resource A is later than a time domain end position of the time domain resource B, there is a nested relationship between the time domain resource A and the time domain resource B; or if a frequency domain start position of a frequency domain resource A occupied by the information A is earlier than a frequency domain start position of a frequency domain resource B occupied by the information B, and a frequency domain end position of the frequency domain resource A is later than a frequency domain end position of the frequency domain resource B, there is a nested relationship between the frequency domain resource A and the frequency domain resource B.

The nested relationship may be expressed as an overlapping relationship, a coinciding relationship, a coverage relationship, or an inclusion relationship. For example, that the information A is nested with the information B may also be described as that the information A overlaps the information B, the information A coincides with the information B, the information A covers the information B, or the information A includes the information B. In the following, for ease of description, these expressions convey the same meaning when used interchangeably.

It should be understood that the following is merely for ease of understanding and description. In some embodiments, interaction between a first apparatus and a second apparatus is used as an example for description. Uplink transmission or downlink transmission may be performed between the first apparatus and the second apparatus. For example, the first apparatus may be implemented as a network device (for example, the base station 110a in FIG. 1) or a component in a network device, and the second apparatus may be implemented as a terminal device (for example, the terminal 120a in FIG. 1) or a component in a terminal device. Alternatively, the first apparatus may be implemented as a terminal device (for example, the terminal 120a in FIG. 1) or a component in a terminal device, and the second apparatus may be implemented as a network device (for example, the base station 110a in FIG. 1) or a component in a network device. Sidelink transmission may be performed between the first apparatus and the second apparatus. For example, both the first apparatus and the second apparatus may be implemented as a terminal device or a component in a terminal device. For example, the first apparatus may be implemented as the terminal 120a in FIG. 1, and the second apparatus may be implemented as the terminal 120e in FIG. 1. Both the first apparatus and the second apparatus may be implemented as a network device or a component in a network device. For example, the first apparatus may be implemented as the base station 110a in FIG. 1, and the second apparatus may be implemented as the base station 110b in FIG. 1.

It should be further understood that all communication devices (for example, a first communication device, a second communication device, and a third communication device) in the following may be terminal devices or network devices.

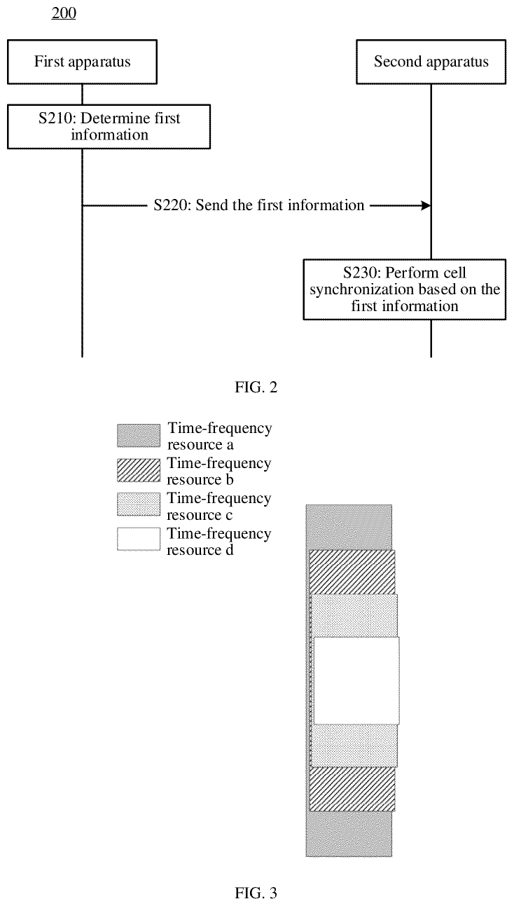

FIG. 2 is a schematic flowchart of a cell synchronization method 200 according to an embodiment of this application. As shown in FIG. 2, the method 200 may include at least a part of content of the following S210 to S230.
S210: A first apparatus determines first information, where the first information includes first synchronization information, the first synchronization information is used by a first communication device to perform cell synchronization, second synchronization information in the first synchronization information is used by a second communication device to perform cell synchronization, and a type of the first communication device is different from a type of the second communication device.
S220: The first apparatus sends the first information to a second apparatus. Correspondingly, the second apparatus receives the first information sent by the first apparatus.
S230: The second apparatus performs cell synchronization based on the first information.

As described above, a type of a communication device may be related to a communication service scenario in which the communication device is used. When the communication device is of a different type, a bandwidth of the communication device in a corresponding communication service scenario is generally different. Therefore, in different communication service scenarios, bandwidths occupied by information for synchronization that is transmitted by the communication device during cell synchronization are different.

The information for cell synchronization may be, for example, a synchronization signal/PBCH block (SSB). Optionally, the first information in this embodiment of this application may include an SSB. For example, the first synchronization information may include a first primary synchronization signal (PSS) and/or a first secondary synchronization signal (SSS).

The first synchronization information includes the second synchronization information. In other words, the second synchronization information may be partial information of the first synchronization information, or the second synchronization information is sub-information of the first synchronization information. For example, the second synchronization information may include a second PSS and/or a second SSS.

For example, there is a nested relationship between a bit sequence of the first synchronization information and a bit sequence of the second synchronization information. If the bit sequence of the first synchronization information includes 21 bits (for example, a 0^{th} bit to a 20^{th} bit), the bit sequence of the second synchronization information may include 11 (for example, the 5^{th} bit to the 15^{th} bit) of the 21 bits.

It should be noted that for ease of understanding, only two different types of communication devices are used as an example for description in this application, but a number of types of communication devices that perform cell synchronization and that can be indicated by the first information is not limited. The number of types of communication devices depends on a configuration of a network device. Actually, the network device may configure two types (types), three types, or another value. When the first information can indicate three or more types of communication devices to perform cell synchronization, more sub-information may be nested in the first synchronization information. For example, third synchronization information in the second synchronization information is used by a third communication device to perform cell synchronization. A type of the third communication device is different from the type of the first communication device, and the type of the third communication device is different from the type of the second communication device. For example, the bit sequence of the first synchronization information includes the 0^{th} bit to the 20^{th} bit, the bit sequence of the second synchronization information may include the 5^{th} bit to the 15^{th} bit in the 21 bits, and a bit sequence of the third synchronization information may include the 7^{th} bit to the 13^{th} bit in the 21 bits. By analogy, fourth synchronization information in the third synchronization information is used by a fourth communication device to perform cell synchronization, and the like.

It should be further understood that there may not be a nested relationship between the third synchronization information and the second synchronization information. For example, the bit sequence of the first synchronization information includes the 0^{th} bit to the 20^{th} bit, the bit sequence of the second synchronization information may include the 0^{th} bit to the 10^{th} bit in the 21 bits, and the bit sequence of the third synchronization information may include the 11^{th} bit to the 20^{th} bit in the 21 bits.

The first synchronization information may be used by one type of communication device (for example, the first communication device) to perform cell synchronization. The second synchronization information in the first synchronization information may be used by another type of communication device (for example, the second communication device) to perform cell synchronization. In this case, the first apparatus sends the first information to the second apparatus, and the second apparatus may obtain corresponding synchronization information (for example, the first synchronization information or the second synchronization information) based on a communication device type to which the second apparatus belongs, to implement cell synchronization.

The second apparatus may be the first communication device or a component in the first communication device. Alternatively, the second apparatus may be the second communication device or a component in the second communication device. Certainly, when the first information further indicates more types of communication devices to perform cell synchronization, the second apparatus may alternatively be another communication device, for example, the third communication device or the fourth communication device.

If the second apparatus is the first communication device or the component in the first communication device, the second apparatus may receive the first synchronization information, and perform cell synchronization based on the first synchronization information. The second apparatus may receive the first synchronization information on a first time-frequency resource. If the second apparatus is the second communication device or the component in the second communication device, and the second apparatus may perform receiving.

In some embodiments, there is also a nested relationship between the first time-frequency resource carrying the first synchronization information and the second time-frequency resource carrying the second synchronization information. It should be noted that the first time-frequency resource includes a time domain resource and a frequency domain resource that carry the first synchronization information. Similarly, the second time-frequency resource includes a time domain resource and a frequency domain resource that carry the second synchronization information.

The nested relationship between the first time-frequency resource and the second time-frequency resource may be a nested relationship between the frequency domain resource of the first time-frequency resource and the frequency domain resource of the second time-frequency resource, and/or a nested relationship between the time domain resource of the first time-frequency resource and the time domain resource of the second time-frequency resource.

For example, that the first time-frequency resource includes the second time-frequency resource may be that the frequency domain resource of the first time-frequency resource includes the frequency domain resource of the second time-frequency resource, and the time domain resource of the first time-frequency resource is the same as the time domain resource of the second time-frequency resource. With reference to FIG. 3, four time-frequency resources having a nested relationship are used as an example for description. An example in which the first information is used by four different types of communication devices to perform cell synchronization is used. A time-frequency resource a carrying the first synchronization information, a time-frequency resource b carrying the second synchronization information, a time-frequency resource c carrying the third synchronization information, and a time-frequency resource d carrying the fourth synchronization information are all the same. In addition, a frequency domain resource of the time-frequency resource a includes a frequency domain resource of the time-frequency resource b, the frequency domain resource of the time-frequency resource b includes a frequency domain resource of the time-frequency resource c, and the frequency domain resource of the time-frequency resource c includes a frequency domain resource of the time-frequency resource d. For example, the time-frequency resource a may occupy 40 RBs, the time-frequency resource b may occupy 20 RBs, the time-frequency resource c may occupy 10 RBs, and the time-frequency resource d may occupy six RBs or one RB.

For example, the type of the communication device includes a type A, a type B, a type C, and a type D. The first synchronization information used by a type-A communication device to perform cell synchronization is a synchronization signal (synchronization signal, SS) 4. The second synchronization information used by a type-B communication device to perform cell synchronization is an SS 3. The third synchronization information used by a type-C communication device to perform cell synchronization is an SS 2. The fourth synchronization information used by a type-D communication device to perform cell synchronization is an SS 1. Frequency domain resources corresponding to the type A, the type B, the type C, and the type D are six RBs (or one RB), 10 RBs, 20 RBs, 40 RBs, and the like. The type-A communication device (for example, in an NB-IoT communication service scenario) accesses the type-A SS 4. The type-B communication device (for example, in a URLLC communication service scenario) accesses the type-B SS 3. The type-C communication device (for example, in an eMBB communication service scenario) accesses the type-C SS 2. The type-D communication device (for example, in a CPE communication service scenario) accesses the type-D SS 1. The SS includes a PSS and/or an SSS.

For example, for subcarriers occupied by the first synchronization information to the fourth synchronization information, refer to the following Table 1. For example, sequence numbers of subcarriers occupied by the first synchronization information (including a PSS and/or an SSS) are 0 to 479, sequence numbers of subcarriers occupied by the second synchronization information (including a PSS and/or an SSS) are 120 to 359, sequence numbers of subcarriers occupied by the third synchronization information (including a PSS and/or an SSS) are 180 to 299, and sequence numbers of subcarriers occupied by the fourth synchronization information (including a PSS and/or an SSS) are 204 to 275.

TABLE 1

| | Sequence numbers | Sequence numbers | Sequence numbers | Sequence numbers |
|---|---|---|---|---|
| | of subcarriers | of subcarriers | of subcarriers | of subcarriers |
| | occupied by the | occupied by the | occupied by the | occupied by |
| | fourth | third | second | the first |
| Channel/ | synchronization | synchronization | synchronization | synchronization |
| Signal | information | information | information | information |
| PSS | 204, 205, 206, . . ., | 180, 181, 182, . . ., | 120, 121, 122, . . ., | 0, 1, 2, . . ., 477, 478, |
| | 273, 274, and 275 | 297, 298, and 299 | 357, 358, and 359 | and 479 |
| SSS | 204, 205, 206, . . ., | 180, 181, 182, . . ., | 120, 121, 122, . . ., | 0, 1, 2, . . ., 477, 478, |
| | 273, 274, and 275 | 297, 298, and 299 | 357, 358, and 359 | and 479 |

Therefore, in this embodiment of this application, the first synchronization information is introduced. The first synchronization information is used by the first communication device to perform cell synchronization. The second synchronization information in the first synchronization information is used by the second communication device to perform cell synchronization. After sending the first synchronization information to the first communication device, the first apparatus does not need to separately send the second synchronization information to the second communication device. This reduces signaling overheads during cell synchronization, and further improves communication performance.

In some embodiments, the first information further includes broadcast information. For example, the broadcast information may be carried on a physical broadcast channel (physical broadcast channel, PBCH). The broadcast information in the first information may be used by at least two types of communication devices (for example, the first communication device and the second communication device) to perform cell synchronization.

In a first example, the broadcast information may include broadcast information shared by the at least two types of communication devices. For example, the broadcast information may be common information. The common information may include at least one of a cell identity, a frame number, and a subcarrier spacing of a physical downlink control channel (PDCCH) and a physical downlink shared channel (PDSCH) in a system information block (SIB) 1.

In the first example, the broadcast information may be carried on a fourth time-frequency resource, and the second apparatus may receive the broadcast information on the fourth time-frequency resource.

Optionally, to improve coverage of the broadcast information, the broadcast information may be repeatedly transmitted. A third time-frequency resource includes the fourth time-frequency resource, and a resource other than the fourth time-frequency resource in the third time-frequency resource may be used to repeatedly transmit the broadcast information. The second apparatus may directly receive the repeatedly transmitted broadcast information on the resource other than the fourth time-frequency resource in the third time-frequency resource. Alternatively, the second apparatus may determine, based on the communication device type to which the second apparatus belongs, whether to receive the repeatedly transmitted broadcast information.

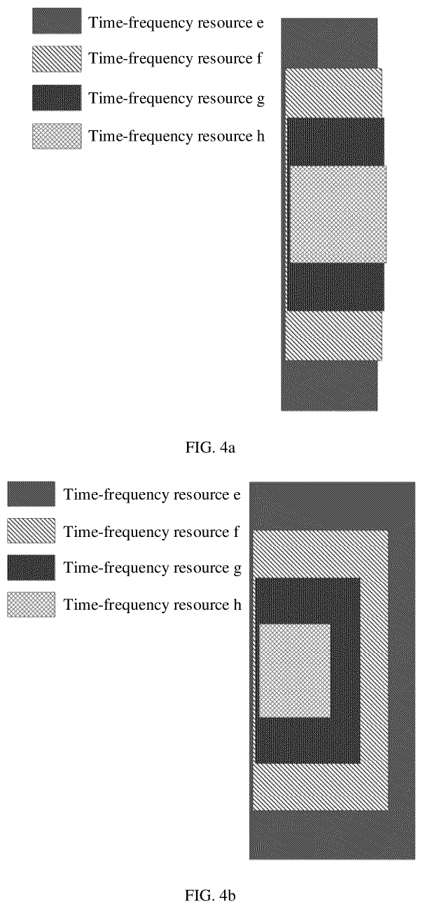

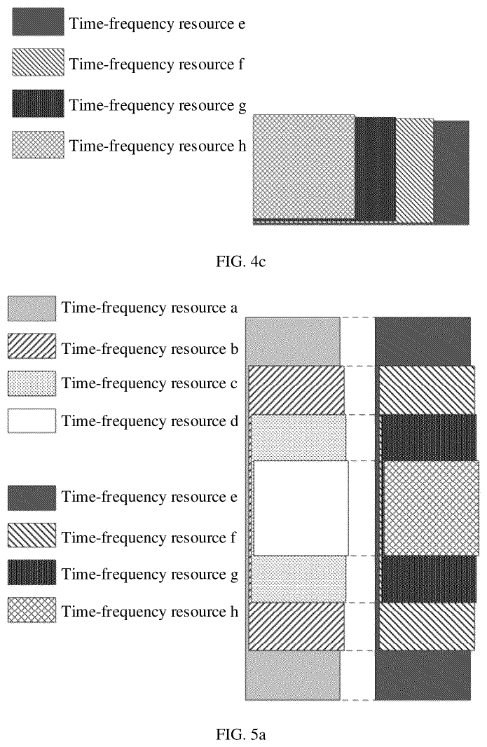

For a nested relationship between the third time-frequency resource and the fourth time-frequency resource, refer to FIG. 4a to FIG. 4c. An example in which four time-frequency resources are nested is used for description in FIG. 4a to FIG. 4c. The third time-frequency resource and the fourth time-frequency resource are among the four time-frequency resources.

Refer to FIG. 4a. Time domain resources of a time-frequency resource e, a time-frequency resource f, a time-frequency resource g, and a time-frequency resource h are the same, and frequency domain resources have a nested relationship. For example, a frequency domain resource of the time-frequency resource e includes a frequency domain resource of the time-frequency resource f, the frequency domain resource of the time-frequency resource f includes a frequency domain resource of the time-frequency resource g, and the frequency domain resource of the time-frequency resource g includes a frequency domain resource of the time-frequency resource h.

For example, the type of the communication device includes the type A, the type B, the type C, and the type D. The frequency domain resources corresponding to the type A, the type B, the type C, and the type D are six RBs (or one RB), 10 RBs, 20 RBs, and 40 RBs.

A time domain resource of a PBCH may start from a symbol immediately following an SS, and time domain resources of PBCHs corresponding to various types of communication devices are the same, for example, all occupy one symbol.

Refer to FIG. 4b. Both time domain resources and frequency domain resources of a time-frequency resource e, a time-frequency resource f, a time-frequency resource g, a time-frequency resource h have a nested relationship. For example, the time-frequency resource e includes the time-frequency resource f, the time-frequency resource f includes the time-frequency resource g, and the time-frequency resource g includes the time-frequency resource h.

For example, the type of the communication device includes the type A, the type B, the type C, and the type D. The frequency domain resources corresponding to the type A, the type B, the type C, and the type D are six RBs (or one RB), 10 RBs, 20 RBs, and 40 RBs. A time domain resource of a PBCH may start from a symbol immediately following an SS, and PBCHs corresponding to various types of communication devices occupy nested symbols. For example, a symbol occupied by a PBCH corresponding to the type A is an SS symbol+1, a symbol occupied by a PBCH corresponding to the type B is the SS symbol+1 and the SS symbol+2, a symbol occupied by a PBCH corresponding to the type C is the SS symbol+1, the SS symbol+2, and the SS symbol+3, and a symbol occupied by a PBCH corresponding to the type D is the SS symbol+1, the SS symbol+2, the SS symbol+3, and the SS symbol+4.

Refer to FIG. 4c. Frequency domain resources of a time-frequency resource e, a time-frequency resource f, a time-frequency resource g, and a time-frequency resource h are the same, and time domain resources have a nested relationship. For example, a time domain resource of the time-frequency resource e includes a time domain resource of the time-frequency resource f, the time domain resource of the time-frequency resource f includes a time domain resource of the time-frequency resource g, and the time domain resource of the time-frequency resource g includes a time domain resource of the time-frequency resource h.

For example, frequency domain resources occupied by PBCHs corresponding to the type A, the type B, the type C, and the type D are the same. The frequency domain resources occupied by the PBCHs corresponding to the type A, the type B, the type C, and the type D may be the same as a minimum frequency domain resource in frequency domain resources occupied by SSs (for example, the SS 1 to the SS 4). Time domain resources occupied by the PBCHs corresponding to the type A, the type B, the type C, and the type D may start from symbols immediately following the SSs, and occupy nested symbols. For example, a symbol occupied by a PBCH corresponding to the type A is an SS symbol+1, a symbol occupied by a PBCH corresponding to the type B is the SS symbol+1 and the SS symbol+2, a symbol occupied by a PBCH corresponding to the type C is the SS symbol+1, the SS symbol+2, and the SS symbol+3, and a symbol occupied by a PBCH corresponding to the type D is the SS symbol+1, the SS symbol+2, the SS symbol+3, and the SS symbol+4.

Optionally, in FIG. 4b and FIG. 4c, time domain start positions of the time-frequency resources e to h may be the same, and time domain end positions are different. For example, the time-frequency resource h occupies a time domain symbol 1, the time-frequency resource g occupies time domain symbols 1 and 2, the time-frequency resource f occupies time domain symbols 1 to 3, and the time-frequency resource e occupies time domain symbols 1 to 4.

The third time-frequency resource may be any one of the time-frequency resources e to g in the four time-frequency resources in FIG. 4a to FIG. 4c. When the third time-frequency resource is the time-frequency resource e, the fourth time-frequency resource is any one of the time-frequency resources f to h. When the third time-frequency resource is the time-frequency resource f, the fourth time-frequency resource is either the time-frequency resource g or the time-frequency resource h. When the third time-frequency resource is the time-frequency resource g, the fourth time-frequency resource is the time-frequency resource h.

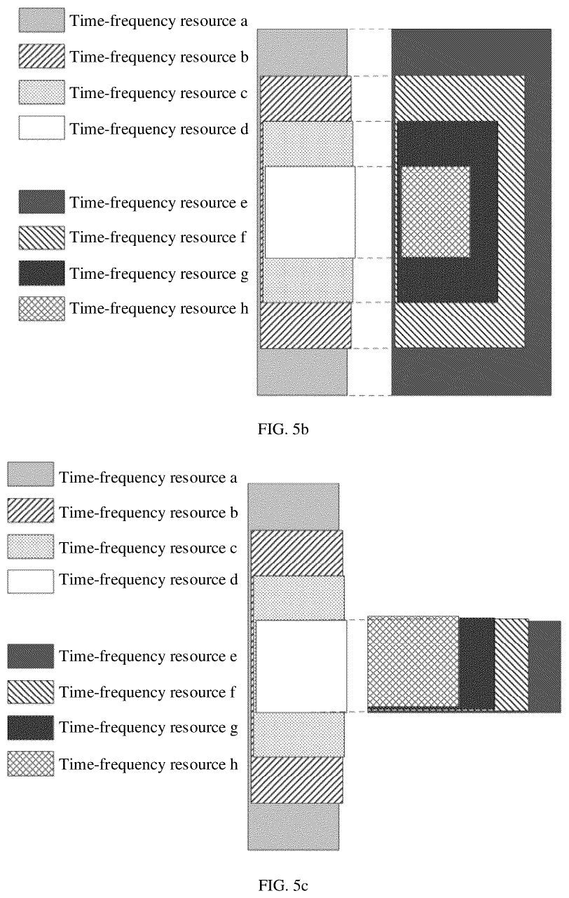

For example, when a frequency domain resource of the third time-frequency resource includes a frequency domain resource of the fourth time-frequency resource, the frequency domain resource of the third time-frequency resource is the same as the frequency domain resource of the first time-frequency resource, and the frequency domain resource of the fourth time-frequency resource is the same as the frequency domain resource of the second time-frequency resource. With reference to FIG. 5a and FIG. 5b, the frequency domain resource of the time-frequency resource e is the same as the frequency domain resource of the time-frequency resource a, the frequency domain resource of the time-frequency resource f is the same as the frequency domain resource of the time-frequency resource b, the frequency domain resource of the time-frequency resource g is the same as the frequency domain resource of the time-frequency resource c, and the frequency domain resource of the time-frequency resource h is the same as the frequency domain resource of the time-frequency resource d.

Optionally, the time domain start positions of the time-frequency resources e to h in FIG. 5a to FIG. 5c may be after a time domain end position of synchronization information (including the first synchronization information and the second synchronization information). In some embodiments, there is no time domain interval between the time-frequency resources e to h carrying the broadcast information and the time-frequency resources a to d carrying the synchronization information. For example, the time-frequency resources a to d occupy a time domain symbol 0, and the time domain start positions of the time-frequency resources e to h are a symbol 1. In some other embodiments, there is a time domain interval between the time-frequency resources e to h carrying the broadcast information and the time-frequency resources a to d carrying the synchronization information. For example, the time-frequency resources a to d occupy a time domain symbol 0, and the time domain start positions of the time-frequency resources e to h are a time domain symbol 2.

For example, when a frequency domain resource of the third time-frequency resource is the same as a frequency domain resource of the fourth time-frequency resource, both the frequency domain resource of the third time-frequency resource and the frequency domain resource of the fourth time-frequency resource may be the same as a frequency domain resource of any one of the time-frequency resources carrying the synchronization information (for example, the first synchronization information and the second synchronization information). With reference to FIG. 5c, the frequency domain resources of the time-frequency resources e to h are the same as the frequency domain resource of the time-frequency resource d.

For example, the first apparatus may send the broadcast information on the fourth time-frequency resource, and repeatedly transmit the broadcast information on a time-frequency resource other than the fourth time-frequency resource in the third time-frequency resource. With reference to FIG. 4a to FIG. 4c, if the fourth time-frequency resource is the time-frequency resource h, and the third time-frequency resource is the time-frequency resource g, the first apparatus may send the broadcast information on the time-frequency resource h, and repeatedly transmit the broadcast information on the time-frequency resource g. It should be understood that the first apparatus may alternatively repeatedly transmit the broadcast information on the time-frequency resource f and the time-frequency resource e.

Different types of communication devices may correspond to different time-frequency resources. For example, the first communication device may correspond to the time-frequency resource e, the second communication device may correspond to the time-frequency resource f, the third communication device may correspond to the time-frequency resource g, and the fourth communication device may correspond to the time-frequency resource h.

When the second apparatus is the first communication device or the component in the first communication device, the second apparatus may receive the broadcast information on the fourth time-frequency resource, and receive the repeatedly transmitted broadcast information on the time-frequency resource other than the fourth time-frequency resource in the third time-frequency resource. With reference to FIG. 4a to FIG. 4c, if the first communication device corresponds to the time-frequency resource e, when the second apparatus is the first communication device or the component in the first communication device, the second apparatus may receive the broadcast information on the time-frequency resource g, and receive the repeatedly transmitted broadcast information on the time-frequency resources e to g.

In a second example, the broadcast information may include respective broadcast information of the at least two types of communication devices. For example, the broadcast information may include first broadcast information used by the first communication device to perform cell synchronization, and second broadcast information used by the second communication device to perform cell synchronization.

In an example, the first information further includes the first broadcast information. The first broadcast information is used by the first communication device to perform cell synchronization, and the second broadcast information in the first broadcast information is used by the second communication device to perform cell synchronization.

Optionally, the first broadcast information is carried on a third time-frequency resource, and the second broadcast information is carried on a fourth time-frequency resource. The third time-frequency resource includes the fourth time-frequency resource.

In the second example, respective broadcast information (for example, the first broadcast information and the second broadcast information) of different types of communication devices may be independent of each other. For example, there is no nested relationship between bit sequences of the first broadcast information and the second broadcast information, and there is no nested relationship between time-frequency resources. Alternatively, there may be a nested relationship between respective broadcast information (for example, the first broadcast information and the second broadcast information) of different types of communication devices. For example, there is a nested relationship between a third bit sequence included in the first broadcast information and a fourth bit sequence included in the second broadcast information, and/or there is a nested relationship between the third time-frequency resource carrying the first broadcast information and the fourth time-frequency resource carrying the second broadcast information. There is a nested relationship between the first broadcast information and the second broadcast information, which can further reduce signaling overheads during cell synchronization and improve communication performance.

For the nested relationship between the third time-frequency resource carrying the first broadcast information and the fourth time-frequency resource carrying the second broadcast information, refer to the descriptions of the nested relationship between the third time-frequency resource and the fourth time-frequency resource in the first example.

In the second example, the third bit sequence included in the first broadcast information includes the fourth bit sequence included in the second broadcast information, and a part of or all bits in the fourth bit sequence may include common information of the first communication device and the second communication device. The common information is described in the foregoing example.

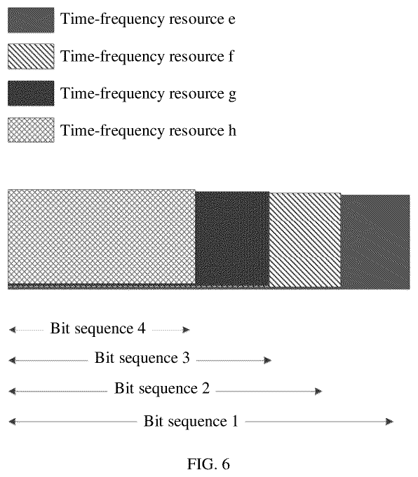

Refer to FIG. 6. It is assumed that the first information may be used by four different types of communication devices (for example, the first communication device to the fourth communication device) to perform cell synchronization. A bit sequence 1 is broadcast information corresponding to the first communication device. A bit sequence 2 is broadcast information corresponding to the second communication device. A bit sequence 3 is broadcast information corresponding to the third communication device. A bit sequence 4 is broadcast information corresponding to the fourth communication device. There is a nested relationship between the bit sequences 1 to 4.

For example, the bit sequences 1 to 4 each may include dedicated information (UE-type specific) of the corresponding communication device, for example, a PDCCH configuration related to a SIB 1. For example, the bit sequence 1 includes dedicated information of the first communication device, the bit sequence 2 includes dedicated information of the second communication device, the bit sequence 3 includes dedicated information of the third communication device, and the bit sequence 4 includes dedicated information of the fourth communication device. In addition, the bit sequence 4 may include common information of the four types of communication devices, the bit sequence 3 may include common information of the first communication device to the third communication device, and the bit sequence 2 may include common information between the first communication device and the second communication device. Optionally, a common bit field carrying the common information and a dedicated bit field carrying the dedicated information may be agreed on in a protocol.

The second apparatus may decode, based on the communication device type to which the second apparatus belongs, information corresponding to the type. For example, when the second apparatus is the first communication device or the component in the first communication device, the second apparatus may decode the common information and the dedicated information of the first communication device from the first broadcast information carried on the third time-frequency resource. When the second apparatus is the second communication device, the second apparatus may decode the common information and the dedicated information of the second communication device from the second broadcast information carried on the fourth time-frequency resource.

It should be noted that this application does not impose a limitation that there is a nested relationship between the broadcast information when there is a nested relationship between the synchronization information in the first information. In other words, in this embodiment of this application, when there is the nested relationship between the first broadcast information and the second broadcast information in the first information, or there is a nested relationship between a time-frequency resource carrying the broadcast information and a time-frequency resource for repeated transmission of the broadcast information, there may be no nested relationship between the first synchronization information and the second synchronization information in the first information, and even whether the first information includes the first synchronization information and the second synchronization information is not limited.

To further reduce the signaling overheads during cell synchronization, in some embodiments, transmission cycles of synchronization information and/or broadcast information corresponding to different types of communication devices are different. In the following, transmission cycles of second information and third information corresponding to different types of communication devices are different.

For example, the first information includes the second information and the third information, the second information includes the first synchronization information and/or the first broadcast information, and the third information includes the second synchronization information and/or the second broadcast information. There may be a nested relationship between the second information and the third information. For example, there is the nested relationship between the first synchronization information and the second synchronization information, and/or there is the nested relationship between the first broadcast information and the second broadcast information.

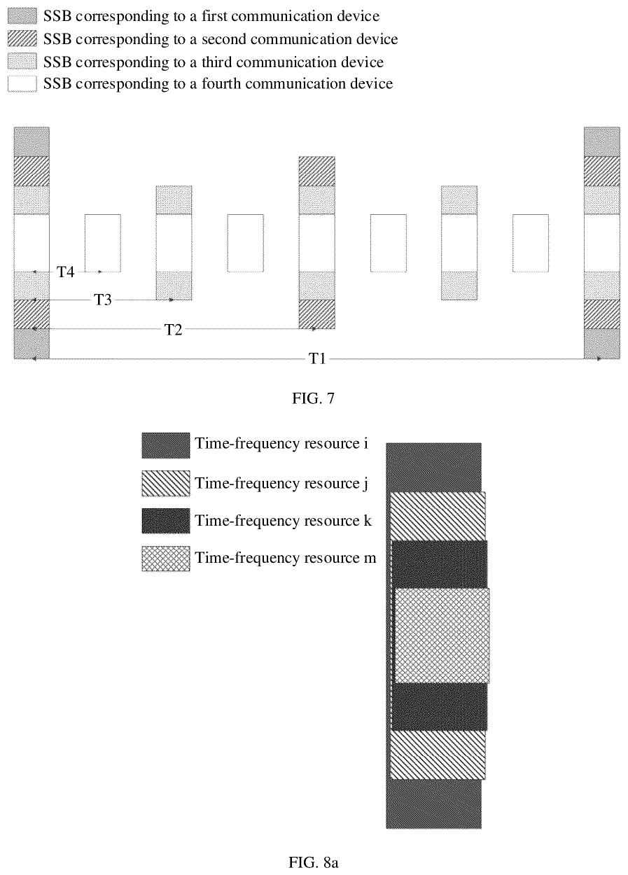

For example, refer to FIG. 7. Four different types of communication devices (for example, the first communication device to the fourth communication device) are used as an example. A transmission cycle of an SSB corresponding to the first communication device is T1, a transmission cycle of an SSB corresponding to the second communication device is T2, a transmission cycle of an SSB corresponding to the third communication device is T3, and a transmission cycle of an SSB corresponding to the fourth communication device is T4.

The first apparatus may separately send the second information and the third information periodically, for example, send the second information based on a first transmission cycle, and send the third information based on a second transmission cycle. When the second apparatus is the first communication device, the second apparatus may receive the second information based on the first transmission cycle. Alternatively, when the second apparatus is the second communication device, the second apparatus may receive the third information based on the second transmission cycle. Alternatively, the second apparatus may perform cell synchronization based on information (for example, the third information) transmitted in a short transmission cycle. In addition, when the second apparatus is the first communication device, to improve cell synchronization precision, the second apparatus may perform cell synchronization based on information (for example, the second information) transmitted in a long transmission cycle.

Optionally, the transmission cycle of the second information is longer than the transmission cycle of the third information. It should be understood that the second information occupies more time-frequency resources than the first information, so that setting a long transmission cycle for the second information can reduce resource overheads while ensuring cell synchronization efficiency.

Refer to FIG. 7. The transmission cycle T1 of the SSB corresponding to the first communication device, the transmission cycle T2 of the SSB corresponding to the second communication device, the transmission cycle T3 of the SSB corresponding to the third communication device, and the transmission cycle T4 of the SSB corresponding to the fourth communication device are gradually reduced. For example, T4 may be 5 ms, T3 may be 10 ms, T2 may be 20 ms, and T1 may be 40 ms. Each of the first communication device to the fourth communication device may perform cell synchronization based on an SSB transmitted in the transmission cycle T4. Further, each type of communication device continues to perform cell synchronization based on a synchronization precision requirement of the communication device. For example, the first communication device to the third communication device may perform cell synchronization based on SSBs transmitted in the transmission cycle T3, the first communication device and the second communication device may perform cell synchronization based on SSBs transmitted in the transmission cycle T2, and the first communication device may perform cell synchronization based on an SSB transmitted in the transmission cycle T1.

For different types of communication devices, information detection may be performed based on different detection cycles. For example, when the second apparatus is the first communication device or the component in the first communication device, the second apparatus may detect the second information or the third information based on a first detection cycle. When the second apparatus is the second communication device or the component in the second communication device, the second apparatus may detect the third information based on a second detection cycle. Optionally, the first detection cycle is shorter than the second detection cycle, so that cell synchronization precision of the first communication device can be ensured.

Optionally, the communication device may determine a to-be-accessed SSB type as required based on a service requirement (for example, a packet size, reliability, and synchronization precision).

Different SSB types correspond to different types of communication devices. For example, the SSB corresponding to the first communication device is a first-type SSB, the SSB corresponding to the second communication device is a second-type SSB, the SSB corresponding to the third communication device is a third-type SSB, and the SSB corresponding to the fourth communication device is a fourth-type SSB.

For example, for an NB-IoT small-packet user in a scenario requiring low synchronization precision, the fourth-type SSB (or a narrowband SSB) may be accessed, and a detection cycle is long (an SSB on a white resource is detected for a few times, and a number of times of detecting the SSB on the white resource may be less than a first number threshold, for example, 1 or 2). For example, for an eMBB large-packet user in a scenario requiring high synchronization precision, the first-type SSB (or a broadband SSB) may be accessed, and a detection cycle is short (an SSB on a white resource is detected for a plurality of times, an SSB on a gray resource is detected once, and a number of times of detecting the SSB on the white resource may be greater than a second number threshold, for example, 4, 5, or 6).

Optionally, cycles of different SSB types are configured from a perspective of energy saving of the first apparatus. For example, for the narrowband SSB, a cycle is short, and various types of communication devices may perform preliminary synchronization by using narrowband SSBs. For example, for the broadband SSB, a cycle is long, and a communication device with a requirement may receive a broadband SSB to improve synchronization precision.

In some embodiments, the first apparatus may send configuration information to the second apparatus. Correspondingly, the second apparatus receives the configuration information sent by the first apparatus. The configuration information indicates the transmission cycle of the second information and/or the transmission cycle of the third information. For example, the second apparatus may obtain the configuration information through blind detection. For example, the configuration information is configured in a broadcast channel, for example, in system information. Optionally, the configuration information may be carried in higher layer signaling such as radio resource control (RRC) signaling, or carried in physical layer signaling such as downlink control information.

Optionally, the transmission cycle of the second information and/or the transmission cycle of the third information may alternatively be agreed on in the protocol.

It may be understood that the broadcast information further includes indication information indicating a time-frequency resource used by the communication device for communication. For example, the indication information in the broadcast information may indicate time-frequency resources of a control resource set CORESET 0 and/or an initial access bandwidth part (BWP).

For example, indication information in the first broadcast information indicates a fifth time-frequency resource used by the first communication device for communication, and indication information in the second broadcast information indicates a sixth time-frequency resource used by the second communication device for communication.

In some embodiments, the fifth time-frequency resource and the sixth time-frequency resource may be mutually independent time-frequency resources.

In some other embodiments, to further reduce the signaling overheads, there is a nested relationship between the fifth time-frequency resource and the sixth time-frequency resource. The fifth time-frequency resource may include the sixth time-frequency resource. The nested relationship between the fifth time-frequency resource and the sixth time-frequency resource is similar to the nested relationship between the third time-frequency resource and the fourth time-frequency resource. For example, there may be a frequency domain nested relationship between the fifth time-frequency resource and the sixth time-frequency resource. For example, a frequency domain resource of the fifth time-frequency resource may include a frequency domain resource of the sixth time-frequency resource, and a time domain resource of the fifth time-frequency resource is the same as a time domain resource of the sixth time-frequency resource. There may be a time domain nested relationship between the fifth time-frequency resource and the sixth time-frequency resource. For example, a frequency domain resource of the fifth time-frequency resource is the same as a frequency domain resource of the sixth time-frequency resource, and a time domain resource of the fifth time-frequency resource includes a time domain resource of the sixth time-frequency resource. There may be a time-frequency domain nested relationship between the fifth time-frequency resource and the sixth time-frequency resource. For example, a frequency domain resource of the fifth time-frequency resource includes a frequency domain resource of the sixth time-frequency resource, and a time domain resource of the fifth time-frequency resource includes a time domain resource of the sixth time-frequency resource.

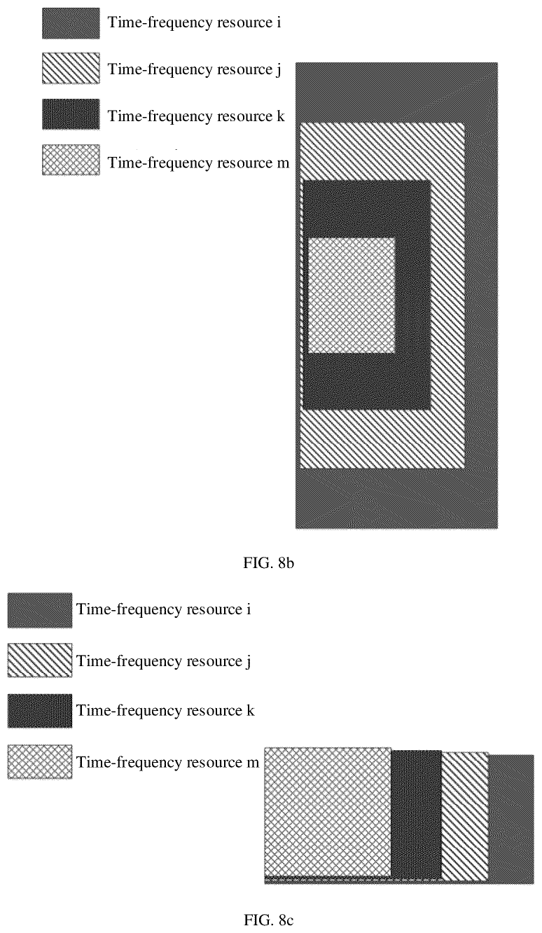

Refer to FIG. 8a. Time domain resources of a time-frequency resource i, a time-frequency resource j, a time-frequency resource k, and a time-frequency resource m are the same, and frequency domain resources have a nested relationship. For example, a frequency domain resource of the time-frequency resource i includes a frequency domain resource of the time-frequency resource j, the frequency domain resource of the time-frequency resource j includes a frequency domain resource of the time-frequency resource k, and the frequency domain resource of the time-frequency resource k includes a frequency domain resource of the time-frequency resource m. Refer to FIG. 8b. Both time domain resources and frequency domain resources of a time-frequency resource i, a time-frequency resource j, a time-frequency resource k, a time-frequency resource m have a nested relationship. For example, the time-frequency resource i includes the time-frequency resource j, the time-frequency resource j includes the time-frequency resource k, and the time-frequency resource k includes the time-frequency resource m. Refer to FIG. 8c. Frequency domain resources of a time-frequency resource i, a time-frequency resource j, a time-frequency resource k, and a time-frequency resource m are the same, and time domain resources have a nested relationship. For example, a time domain resource of the time-frequency resource i includes a time domain resource of the time-frequency resource j, the time domain resource of the time-frequency resource j includes a time domain resource of the time-frequency resource k, and the time domain resource of the time-frequency resource k includes a time domain resource of the time-frequency resource m.

Optionally, in FIG. 8b and FIG. 8c, time domain start positions of the time-frequency resources i, j, k, and m may be the same, and time domain end positions are different. For example, the time-frequency resource m occupies a time domain symbol 6, the time-frequency resource k occupies time domain symbols 6 and 7, the time-frequency resource j occupies time domain symbols 6 to 8, and the time-frequency resource i occupies time domain symbols 6 to 9.

The fifth time-frequency resource may be any one of the time-frequency resources i, j, k, and m in the four time-frequency resources in FIG. 8a to FIG. 8c. When the fifth time-frequency resource is the time-frequency resource i, the sixth time-frequency resource is any one of the time-frequency resources j, k, and m. When the fifth time-frequency resource is the time-frequency resource j, the sixth time-frequency resource is either the time-frequency resource k or the time-frequency resource m. When the fifth time-frequency resource is the time-frequency resource k, the sixth time-frequency resource is the time-frequency resource m.

For example, when the frequency domain resource of the fifth time-frequency resource includes the frequency domain resource of the sixth time-frequency resource, the frequency domain resource of the fifth time-frequency resource is the same as the frequency domain resource of the first time-frequency resource, and the frequency domain resource of the sixth time-frequency resource is the same as the frequency domain resource of the second time-frequency resource. With reference to FIG. 8a and FIG. 8b, the frequency domain resource of the time-frequency resource i is the same as the frequency domain resource of the time-frequency resource a, the frequency domain resource of the time-frequency resource j is the same as the frequency domain resource of the time-frequency resource b, the frequency domain resource of the time-frequency resource k is the same as the frequency domain resource of the time-frequency resource c, and the frequency domain resource of the time-frequency resource m is the same as the frequency domain resource of the time-frequency resource d.

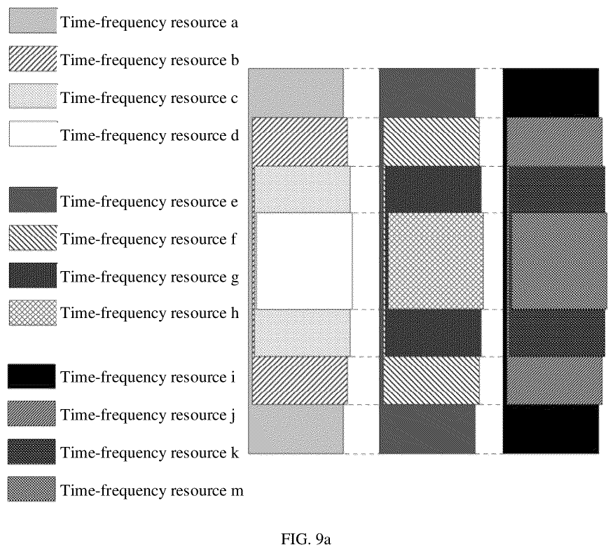

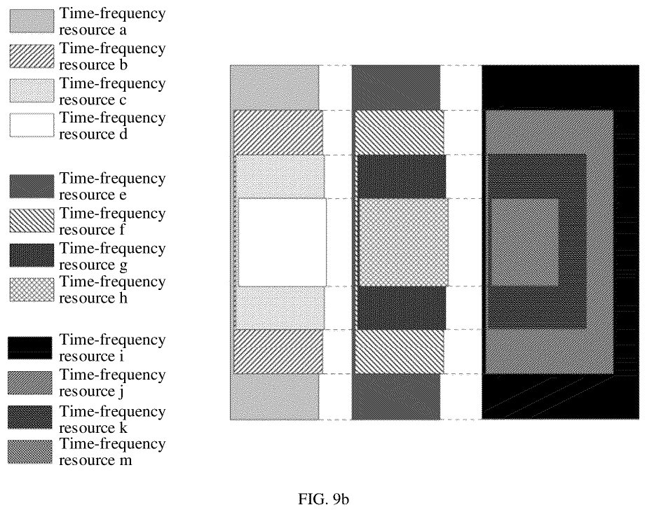

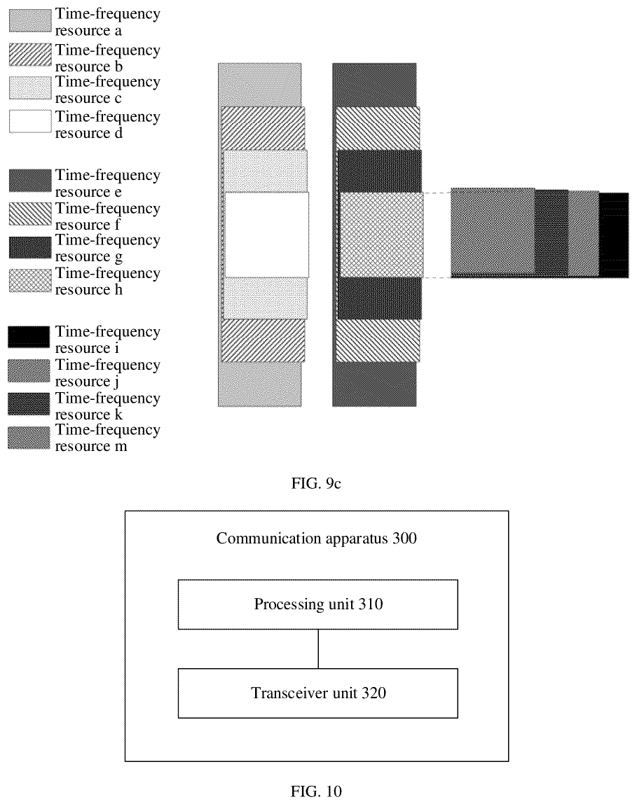

Optionally, the time domain start positions of the time-frequency resources i, j, k, and m in FIG. 9a to FIG. 9c may be after a time domain end position of the broadcast information (including the first broadcast information and the second broadcast information). In FIG. 9a to FIG. 9c, the time-frequency resources e to h in FIG. 5a are used as an example for description. However, this is not limited in this application, that is, FIG. 9a to FIG. 9c do not limit a nested form of the time-frequency resources e to h. In some embodiments, there is no time domain interval between the time-frequency resources i, j, k, and m and the time domain end positions of the time-frequency resources e to h carrying the broadcast information. For example, the time domain end positions of the time-frequency resources e to h are the time domain symbol 5, and the time domain start positions of the time-frequency resources i, j, k, and m are the symbol 6. In some other embodiments, there is a time domain interval between the time-frequency resources i, j, k, and m and the time-frequency resources e to h carrying the broadcast information. For example, the time domain end positions of the time-frequency resources e to h are the time domain symbol 5, and the time domain start positions of the time-frequency resources i, j, k, and m are the time domain symbol 10.

For example, when the frequency domain resource of the fifth time-frequency resource includes the frequency domain resource of the sixth time-frequency resource, the frequency domain resource of the fifth time-frequency resource is the same as the frequency domain resource of the first time-frequency resource, the frequency domain resource of the sixth time-frequency resource is the same as the frequency domain resource of the second time-frequency resource, and both the frequency domain resource of the fifth time-frequency resource and the frequency domain resource of the sixth time-frequency resource may be the same as a frequency domain resource of any one of the time-frequency resources carrying the synchronization information (for example, the first synchronization information and the second synchronization information). With reference to FIG. 9c, the frequency domain resources of the time-frequency resources i, j, k, and m are the same as the frequency domain resource of the time-frequency resource d.

For example, time-frequency resource examples of the CORESET 0 are as follows.

In the time-frequency resource nesting manner in FIG. 8a or FIG. 9a, RB numbers (RB numbers) corresponding to the type A, the type B, the type C, and the type D are 6, 12, 18, and 24, a symbol number (Symbol number) corresponding to the type A is 2, 3, or 4, a symbol number corresponding to the type B is 2, 3, or 4, a symbol number corresponding to the type C is 2, 3, or 4, and a symbol number corresponding to the type D is 2, 3, or 4.

In the time-frequency resource nesting manner in FIG. 8b or FIG. 9b, RB numbers corresponding to the type A, the type B, the type C, and the type D are RB numbers 6, 12, 18, and 24, and symbol numbers corresponding to the type A, the type B, the type C, and the type D are 1, 2, 3, and 4, or symbol numbers corresponding to the type A, the type B, the type C, and the type D are 2, 3, 4, and 5.

In the time-frequency resource nesting manners in FIG. 8c and FIG. 9c, RB numbers corresponding to the type A, the type B, the type C, and the type D are all 6, and symbol numbers corresponding to the type A, the type B, the type C, and the type D are 1, 2, 3, and 4, or symbol numbers corresponding to the type A, the type B, the type C, and the type D are 2, 3, 4, and 5.

In some embodiments, a meaning of the indication information in the first broadcast information has a correspondence with the type of the first communication device, and/or a meaning of the indication information in the second broadcast information has a correspondence with the type of the second communication device. In other words, different types of communication devices correspond to different bit meanings of the indication information. The following provides an example description with reference to at least one row or at least one column in Table 2 to Table 5.

Optionally, the first communication device determines the meaning of the indication information in the first broadcast information based on the type of the first communication device.

Optionally, the second communication device determines the meaning of the indication information in the second broadcast information based on the type of the second communication device.

Four types of communication devices (for example, the first communication device to the fourth communication device) are used as an example. In the resource nesting manner in FIG. 9a, when the second apparatus is different types of communication devices (or components in the communication devices), for time-frequency resources determined after the indication information is received, refer to the following Table 2.

TABLE 2

| | Fourth communication | | | Third communication | | | Second communication | | | First communication | | |
|---|---|---|---|---|---|---|---|---|---|---|---|---|
| | device | | | device | | | device | | | device | | |
| | | Time | | | Time | | | Time | | | Time | |
| | | domain | | | domain | | | domain | | | domain | |
| | RB | symbol | Offset | RB | symbol | Offset | RB | symbol | Offset | RB | symbol | Offset |
| Index | number | number | (offset) | number | number | (offset) | number | number | (offset) | number | number | (offset) |
| 0 | 1 or 6 | 1 | 0 | 12 | 1 | 0 | 18 | 1 | 0 | 24 | 1 | 0 |
| 1 | 1 or 6 | 1 | 1 | 12 | 1 | 2 | 18 | 1 | 4 | 24 | 1 | 6 |
| 2 | 1 or 6 | 1 | 2 | 12 | 1 | 4 | 18 | 1 | 6 | 24 | 1 | 8 |
| 3 | 1 or 6 | 1 | 3 | 12 | 1 | 6 | 18 | 1 | 8 | 24 | 1 | 12 |

Four types of communication devices (for example, the first communication device to the fourth communication device) are used as an example. In the resource nesting manner in FIG. 9b, when the second apparatus is different types of communication devices (or components in the communication devices), for time-frequency resources determined after the indication information is received, refer to the following Table 3.

TABLE 3

| | Fourth communication | | | Third communication | | | Second communication | | | First communication | | |
|---|---|---|---|---|---|---|---|---|---|---|---|---|
| | device | | | device | | | device | | | device | | |
| | | Time | | | Time | | | Time | | | Time | |
| | | domain | | | domain | | | domain | | | domain | |
| | RB | symbol | Offset | RB | symbol | Offset | RB | symbol | Offset | RB | symbol | Offset |
| Index | number | number | (offset) | number | number | (offset) | number | number | (offset) | number | number | (offset) |
| 0 | 1 or 6 | 1 | 0 | 12 | 2 | 0 | 18 | 3 | 0 | 24 | 4 | 0 |
| 1 | 1 or 6 | 1 | 1 | 12 | 2 | 2 | 18 | 3 | 4 | 24 | 4 | 6 |
| 2 | 1 or 6 | 1 | 2 | 12 | 2 | 4 | 18 | 3 | 6 | 24 | 4 | 8 |
| 3 | 1 or 6 | 1 | 3 | 12 | 2 | 6 | 18 | 3 | 8 | 24 | 4 | 12 |

Four types of communication devices (for example, the first communication device to the fourth communication device) are used as an example. In the resource nesting manner in FIG. 9c, when the second apparatus is different types of communication devices (or components in the communication devices), for time-frequency resources determined after the indication information is received, refer to the following Table 4.

TABLE 4

| | Fourth communication | | | Third communication | | | Second communication | | | First communication | | |
|---|---|---|---|---|---|---|---|---|---|---|---|---|
| | device | | | device | | | device | | | device | | |
| | | Time | | | Time | | | Time | | | Time | |
| | | domain | | | domain | | | domain | | | domain | |
| | RB | symbol | Offset | RB | symbol | Offset | RB | symbol | Offset | RB | symbol | Offset |
| Index | number | number | (offset) | number | number | (offset) | number | number | (offset) | number | number | (offset) |
| 0 | 1 or 6 | 1 | 0 | 1 or 6 | 2 | 0 | 1 or 6 | 3 | 0 | 1 or 6 | 4 | 0 |
| 1 | 1 or 6 | 1 | 1 | 1 or 6 | 2 | 1 | 1 or 6 | 3 | 1 | 1 or 6 | 4 | 1 |
| 2 | 1 or 6 | 1 | 2 | 1 or 6 | 2 | 2 | 1 or 6 | 3 | 2 | 1 or 6 | 4 | 2 |
| 3 | 1 or 6 | 1 | 3 | 1 or 6 | 2 | 3 | 1 or 6 | 3 | 3 | 1 or 6 | 4 | 3 |

In the foregoing Table 2 to Table 4, the offset may be a frequency domain offset (including a frequency domain upward offset and/or a frequency domain downward offset) of the CORESET 0 (or the initial BWP) relative to the PBCH. It should be understood that this is not limited in this application. For example, the offset may alternatively be a frequency domain offset of the CORESET 0 (or the initial BWP) relative to a reference point (for example, a point A).

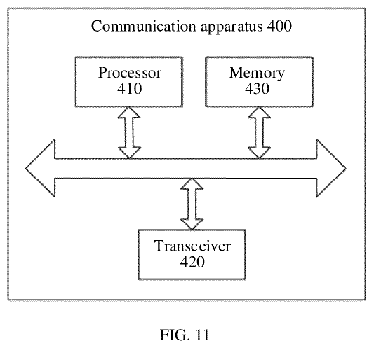

The foregoing describes in detail the method provided in embodiments of this application with reference to FIG. 2 and FIG. 9. The following describes in detail an apparatus provided in embodiments of this application with reference to FIG. 10 and FIG. 11.

FIG. 10 is a diagram of a structure of a communication apparatus 300 according to an embodiment of this application. As shown in FIG. 10, the communication apparatus 300 may include a processing unit 310 and a transceiver unit 320.

Optionally, the communication apparatus 300 may be used in the first apparatus in the foregoing method embodiment.

When the communication apparatus 300 is used in the first apparatus, the processing unit 310 may be configured to determine first information, where the first information includes first synchronization information, the first synchronization information is used by a first communication device to perform cell synchronization, second synchronization information in the first synchronization information is used by a second communication device to perform cell synchronization, and a type of the first communication device is different from a type of the second communication device. The transceiver unit 320 may be configured to send the first information.

In some embodiments, third synchronization information in the second synchronization information is used by a third communication device to perform cell synchronization. A type of the third communication device is different from the type of the first communication device. The type of the third communication device is different from the type of the second communication device.

In some embodiments, the first synchronization information is carried on a first time-frequency resource, and the second synchronization information is carried on a second time-frequency resource. The first time-frequency resource includes the second time-frequency resource.

In some embodiments, a frequency domain resource of the first time-frequency resource includes a frequency domain resource of the second time-frequency resource, and a time domain resource of the first time-frequency resource is the same as a time domain resource of the second time-frequency resource.

In some embodiments, the first synchronization information includes a first bit sequence, and the second synchronization information includes a second bit sequence. The first bit sequence includes the second bit sequence.

In some embodiments, the first synchronization information includes a first primary synchronization signal and/or a first secondary synchronization signal, and the second synchronization information includes a second primary synchronization signal and/or a second secondary synchronization signal.

In some embodiments, the first information further includes first broadcast information. The first broadcast information is used by the first communication device to perform cell synchronization, and second broadcast information in the first broadcast information is used by the second communication device to perform cell synchronization.

In some embodiments, the first broadcast information is carried on a third time-frequency resource, and the second broadcast information is carried on a fourth time-frequency resource. The third time-frequency resource includes the fourth time-frequency resource.

In some embodiments, the first broadcast information includes a third bit sequence, and the second broadcast information includes a fourth bit sequence. The third bit sequence includes the fourth bit sequence.

In some embodiments, a part of the fourth bit sequence includes common information of the first communication device and the second communication device.

In some embodiments, the first information further includes broadcast information, and the broadcast information is used by the first communication device and the second communication device to perform cell synchronization. The broadcast information is carried on the fourth time-frequency resource. A resource other than the fourth time-frequency resource in the third time-frequency resource is used to repeatedly transmit the broadcast information.

In some embodiments, a frequency domain resource of the third time-frequency resource includes a frequency domain resource of the fourth time-frequency resource, and a time domain resource of the third time-frequency resource is the same as a time domain resource of the fourth time-frequency resource, or a time domain resource of the third time-frequency resource includes a time domain resource of the fourth time-frequency resource. Alternatively, a frequency domain resource of the third time-frequency resource is the same as a frequency domain resource of the fourth time-frequency resource, and a time domain resource of the third time-frequency resource includes a time domain resource of the fourth time-frequency resource.

In some embodiments, when the frequency domain resource of the third time-frequency resource includes the frequency domain resource of the fourth time-frequency resource, the frequency domain resource of the third time-frequency resource is the same as the frequency domain resource of the first time-frequency resource, the frequency domain resource of the fourth time-frequency resource is the same as the frequency domain resource of the second time-frequency resource, the first time-frequency resource is used to carry the first synchronization information, and the second time-frequency resource is used to carry the second synchronization information.

In some embodiments, the broadcast information is carried on a physical broadcast channel PBCH.

In some embodiments, a transmission cycle of second information is different from a transmission cycle of third information in the first information. The second information includes the first synchronization information and/or the first broadcast information. The third information includes the second synchronization information and/or the second broadcast information.

In some embodiments, the transmission cycle of the second information is longer than the transmission cycle of the third information.

In some embodiments, the transceiver unit 320 is further configured to send configuration information, where the configuration information indicates the transmission cycle of the second information and/or the transmission cycle of the third information.

In some embodiments, a fifth time-frequency resource includes a sixth time-frequency resource. The fifth time-frequency resource is a time-frequency resource that is indicated by indication information in the first broadcast information and that is used by the first communication device for communication. The sixth time-frequency resource is a time-frequency resource that is indicated by indication information in the second broadcast information and that is used by the second communication device for communication.

In some embodiments, the fifth time-frequency resource includes the sixth time-frequency resource. A frequency domain resource of the fifth time-frequency resource includes a frequency domain resource of the sixth time-frequency resource, and a time domain resource of the fifth time-frequency resource is the same as a time domain resource of the sixth time-frequency resource, or a time domain resource of the fifth time-frequency resource includes a time domain resource of the sixth time-frequency resource. Alternatively, a frequency domain resource of the fifth time-frequency resource is the same as a frequency domain resource of the sixth time-frequency resource, and a time domain resource of the fifth time-frequency resource includes a time domain resource of the sixth time-frequency resource.

In some embodiments, when the frequency domain resource of the fifth time-frequency resource includes the frequency domain resource of the sixth time-frequency resource, the frequency domain resource of the fifth time-frequency resource is the same as the frequency domain resource of the first time-frequency resource, the frequency domain resource of the sixth time-frequency resource is the same as the frequency domain resource of the second time-frequency resource, the first time-frequency resource is used to carry the first synchronization information, and the second time-frequency resource is used to carry the second synchronization information.

In some embodiments, the indication information indicates one of the following time-frequency resources: a control resource set CORESET 0 and an initial access bandwidth part BWP.

In some embodiments, a meaning of the indication information in the first broadcast information has a correspondence with the type of the first communication device, and/or a meaning of the indication information in the second broadcast information has a correspondence with the type of the second communication device.

Optionally, the communication apparatus 300 may be used in the second apparatus in the foregoing method embodiment.

When the communication apparatus 300 is used in the second apparatus, the transceiver unit 320 may be configured to receive first information, where the first information includes first synchronization information, the first synchronization information is used by a first communication device to perform cell synchronization, second synchronization information in the first synchronization information is used by a second communication device to perform cell synchronization, and a type of the first communication device is different from a type of the second communication device. The processing unit 310 may perform cell synchronization based on the first information.

In some embodiments, third synchronization information in the second synchronization information is used by a third communication device to perform cell synchronization. A type of the third communication device is different from the type of the first communication device. The type of the third communication device is different from the type of the second communication device.

In some embodiments, the first synchronization information is carried on a first time-frequency resource, and the second synchronization information is carried on a second time-frequency resource. The first time-frequency resource includes the second time-frequency resource.

In some embodiments, a frequency domain resource of the first time-frequency resource includes a frequency domain resource of the second time-frequency resource, and a time domain resource of the first time-frequency resource is the same as a time domain resource of the second time-frequency resource.

In some embodiments, the first synchronization information includes a first bit sequence, and the second synchronization information includes a second bit sequence. The first bit sequence includes the second bit sequence.

In some embodiments, the first synchronization information includes a first primary synchronization signal and/or a first secondary synchronization signal, and the second synchronization information includes a second primary synchronization signal and/or a second secondary synchronization signal.

In some embodiments, the first information further includes first broadcast information. The first broadcast information is used by the first communication device to perform cell synchronization, and second broadcast information in the first broadcast information is used by the second communication device to perform cell synchronization.

In some embodiments, the first broadcast information is carried on a third time-frequency resource, and the second broadcast information is carried on a fourth time-frequency resource. The third time-frequency resource includes the fourth time-frequency resource.

In some embodiments, the first broadcast information includes a third bit sequence, and the second broadcast information includes a fourth bit sequence. The third bit sequence includes the fourth bit sequence.

In some embodiments, a part of the fourth bit sequence includes common information of the first communication device and the second communication device.

In some embodiments, the first information further includes broadcast information, and the broadcast information is used by the first communication device and the second communication device to perform cell synchronization. The broadcast information is carried on the fourth time-frequency resource. The transceiver unit 320 is specifically configured to receive the broadcast information on the fourth time-frequency resource.

In some embodiments, a type of a communication device corresponds to the third time-frequency resource, and a resource other than the fourth time-frequency resource in the third time-frequency resource is used to repeatedly transmit the broadcast information. The receiving the first information includes: The second apparatus receives the repeatedly transmitted broadcast information on the resource other than the fourth time-frequency resource in the third time-frequency resource.

In some embodiments, a frequency domain resource of the third time-frequency resource includes a frequency domain resource of the fourth time-frequency resource, and a time domain resource of the third time-frequency resource is the same as a time domain resource of the fourth time-frequency resource, or a time domain resource of the third time-frequency resource includes a time domain resource of the fourth time-frequency resource. Alternatively, a frequency domain resource of the third time-frequency resource is the same as a frequency domain resource of the fourth time-frequency resource, and a time domain resource of the third time-frequency resource includes a time domain resource of the fourth time-frequency resource.

In some embodiments, when the frequency domain resource of the third time-frequency resource includes the frequency domain resource of the fourth time-frequency resource, the frequency domain resource of the third time-frequency resource is the same as the frequency domain resource of the first time-frequency resource, the frequency domain resource of the fourth time-frequency resource is the same as the frequency domain resource of the second time-frequency resource, the first time-frequency resource is used to carry the first synchronization information, and the second time-frequency resource is used to carry the second synchronization information.

In some embodiments, the broadcast information is carried on a physical broadcast channel (PBCH).

In some embodiments, a transmission cycle of second information is different from a transmission cycle of third information in the first information. The second information includes the first synchronization information and/or the first broadcast information. The third information includes the second synchronization information and/or the second broadcast information.

In some embodiments, the transmission cycle of the second information is longer than the transmission cycle of the third information.

In some embodiments, the transceiver unit 320 is further configured to send configuration information, where the configuration information indicates the transmission cycle of the second information and/or the transmission cycle of the third information.

In some embodiments, a fifth time-frequency resource includes a sixth time-frequency resource. The fifth time-frequency resource is a time-frequency resource that is indicated by indication information in the first broadcast information and that is used by the first communication device for communication. The sixth time-frequency resource is a time-frequency resource that is indicated by indication information in the second broadcast information and that is used by the second communication device for communication.

In some embodiments, the fifth time-frequency resource includes the sixth time-frequency resource. A frequency domain resource of the fifth time-frequency resource includes a frequency domain resource of the sixth time-frequency resource, and a time domain resource of the fifth time-frequency resource is the same as a time domain resource of the sixth time-frequency resource, or a time domain resource of the fifth time-frequency resource includes a time domain resource of the sixth time-frequency resource. Alternatively, a frequency domain resource of the fifth time-frequency resource is the same as a frequency domain resource of the sixth time-frequency resource, and a time domain resource of the fifth time-frequency resource includes a time domain resource of the sixth time-frequency resource.

In some embodiments, when the frequency domain resource of the fifth time-frequency resource includes the frequency domain resource of the sixth time-frequency resource, the frequency domain resource of the fifth time-frequency resource is the same as the frequency domain resource of the first time-frequency resource, the frequency domain resource of the sixth time-frequency resource is the same as the frequency domain resource of the second time-frequency resource, the first time-frequency resource is used to carry the first synchronization information, and the second time-frequency resource is used to carry the second synchronization information.

In some embodiments, the indication information indicates one of the following time-frequency resources: a control resource set CORESET 0 and an initial access bandwidth part BWP.

In some embodiments, a meaning of the indication information in the first broadcast information has a correspondence with the type of the first communication device, and/or a meaning of the indication information in the second broadcast information has a correspondence with the type of the second communication device.

It should be understood that a specific process in which the units perform the foregoing corresponding steps is described in detail in the foregoing method embodiment.

When the communication apparatus 300 is a communication device, the transceiver unit 320 in the communication apparatus 300 may be implemented by using a transceiver, for example, may correspond to a transceiver 420 in a communication device 400 shown in FIG. 11.

When the communication apparatus 300 is a chip or a chip system configured in a communication device, the transceiver unit 320 in the communication apparatus 300 may be implemented by using an input/output interface, a circuit, or the like.

FIG. 11 is another schematic block diagram of the communication apparatus 400 according to an embodiment of this application. As shown in FIG. 11, the apparatus 400 may include a processor 410, the transceiver 420, and a memory 430. The processor 410, the transceiver 420, and the memory 430 communicate with each other through an internal connection path. The memory 430 is configured to store instructions. The processor 410 is configured to execute the instructions stored in the memory 430, to control the transceiver 420 to send a signal and/or receive a signal.

It should be understood that the communication apparatus 400 may correspond to the first apparatus or the second apparatus in the foregoing method embodiment, and may be configured to perform the steps and/or procedures performed by the first apparatus or the second apparatus in the foregoing method embodiment. Optionally, the memory 430 may include a read-only memory and a random access memory, and provide instructions and data for the processor. A part of the memory may further include a nonvolatile random access memory. The memory 430 may be a separate component, or may be integrated in the processor 410. The processor 410 may be configured to execute the instructions stored in the memory 430. In addition, when the processor 410 executes the instructions stored in the memory, the processor 410 is configured to perform the steps and/or procedures in the method embodiment corresponding to the first apparatus or the second apparatus.

Optionally, the communication apparatus 400 is the first apparatus in the foregoing embodiments.

Optionally, the communication apparatus 400 is the second apparatus in the foregoing embodiments.

The transceiver 420 may include a transmitter and a receiver. The transceiver 420 may further include an antenna, and there may be one or more antennas. The processor 410, the memory 430, and the transceiver 420 may be components integrated into different chips. For example, the processor 410 and the memory 430 may be integrated into a baseband chip, and the transceiver 420 may be integrated into a radio frequency chip. Alternatively, the processor 410, the memory 430, and the transceiver 420 may be components integrated into a same chip. This is not limited in this application.

Optionally, the communication apparatus 400 is a component configured in the first apparatus, for example, a chip or a chip system.

Optionally, the communication apparatus 400 is a component configured in the second apparatus, for example, a chip or a chip system.

Alternatively, the transceiver 420 may be a communication interface, for example, an input/output interface or a circuit. The transceiver 420, the processor 410, and the memory 420 may be integrated into a same chip, for example, integrated into a baseband chip.

This application further provides a processing apparatus, including at least one processor. The at least one processor is configured to execute a computer program stored in a memory, so that the processing apparatus performs a method performed by a test device, the method performed by the first apparatus, or the method performed by the second apparatus in the foregoing method embodiments.

An embodiment of this application further provides a processing apparatus, including a processor and an input/output interface. The input/output interface is coupled to the processor. The input/output interface is configured to input and/or output information. The information includes at least one of instructions and data. The processor is configured to execute a computer program, so that the processing apparatus performs the method performed by the first apparatus or the method performed by the second apparatus in the foregoing method embodiments.

An embodiment of this application further provides a processing apparatus, including a processor and a memory. The memory is configured to store a computer program. The processor is configured to invoke the computer program from the memory and run the computer program, so that the processing apparatus performs the method performed by the first apparatus or the method performed by the second apparatus in the foregoing method embodiments.

It should be understood that the processing apparatus may be one or more chips. For example, the processing apparatus may be a field programmable gate array (FPGA), an application-specific integrated chip (ASIC), a system on chip (SoC), a central processing unit (CPU), a network processor (NP), a digital signal processing circuit (DSP), a micro controller unit (MCU), a programmable controller (PLD), or another integrated chip.

In an implementation process, the steps in the foregoing method can be implemented by using a hardware integrated logical circuit in the processor, or by using instructions in a form of software. The steps of the method disclosed with reference to embodiments of this application may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

It may be understood that the memory in embodiments of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example but not restrictive description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory of the systems and methods described in this specification includes but is not limited to these and any memory of another proper type.

According to the method provided in embodiments of this application, this application further provides a computer program product. The computer program product includes computer program code. When the computer program code is run on a computer, the computer is enabled to perform the method performed by the first apparatus in the foregoing method embodiment, or the computer is enabled to perform the method performed by the second apparatus in the foregoing method embodiment.

According to the method provided in embodiments of this application, this application further provides a computer-readable storage medium. The computer-readable storage medium stores program code. When the program code is run on a computer, the computer is enabled to perform the method performed by the first apparatus in the foregoing method embodiment, or the computer is enabled to perform the method performed by the second apparatus in the foregoing method embodiment.

According to the method provided in embodiments of this application, this application further provides a communication system. The communication system may include the foregoing first apparatus and second apparatus.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or a part of the technical solutions may be implemented in a form of a software product. The computer software product is stored in a storage medium, and includes several instructions for instructing a computer device (which may be a personal computer, a server, a network device, or the like) to perform all or a part of the steps of the method described in embodiments of this application. The foregoing storage medium includes any medium that can store program code, such as a USB flash drive, a removable hard disk drive, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A cell synchronization method, comprising:
determining first information including first synchronization information, wherein the first synchronization information is used by a first communication device to perform cell synchronization, second synchronization information in the first synchronization information is used by a second communication device to perform cell synchronization, and a type of the first communication device is different from a type of the second communication device; and
sending the first information.

2. The method according to claim 1, wherein third synchronization information, in the second synchronization information, is used by a third communication device to perform cell synchronization, a type of the third communication device is different from the type of the first communication device, and the type of the third communication device is different from the type of the second communication device.

3. The method according to claim 1, wherein the first synchronization information is carried on a first time-frequency resource, the second synchronization information is carried on a second time-frequency resource, and the first time-frequency resource includes the second time-frequency resource.

4. The method according to claim 1, wherein a frequency domain resource of the first time-frequency resource includes a frequency domain resource of the second time-frequency resource, and a time domain resource of the first time-frequency resource is the same as a time domain resource of the second time-frequency resource.

5. The method according to claim 1, wherein the first synchronization information includes a first bit sequence, the second synchronization information includes a second bit sequence, and the first bit sequence includes the second bit sequence.

6. The method according to claim 1, wherein the first synchronization information includes a first primary synchronization signal and/or a first secondary synchronization signal, and the second synchronization information includes a second primary synchronization signal and/or a second secondary synchronization signal.

7. The method according to claim 1, wherein the first information further includes first broadcast information used by the first communication device to perform cell synchronization, and second broadcast information, in the first broadcast information, is used by the second communication device to perform cell synchronization.

8. The method according to claim 7, wherein the first broadcast information is carried on the third time-frequency resource, the second broadcast information is carried on the fourth time-frequency resource, and the third time-frequency resource includes the fourth time-frequency resource.

9. The method according to claim 7, wherein the first broadcast information includes a third bit sequence, the second broadcast information includes a fourth bit sequence, and the third bit sequence includes the fourth bit sequence.

10. The method according to claim 9, wherein a part of the fourth bit sequence includes common information of the first communication device and the second communication device.

11. The method according to claim 1, wherein the first information further comprises the broadcast information used by the first communication device and the second communication device to perform cell synchronization, and
the broadcast information is carried on the fourth time-frequency resource, and the resource other than the fourth time-frequency resource, in the third time-frequency resource, is used to repeatedly transmit the broadcast information.

12. The method according to claim 8, wherein
a frequency domain resource of the third time-frequency resource includes a frequency domain resource of the fourth time-frequency resource, and a time domain resource of the third time-frequency resource is the same as a time domain resource of the fourth time-frequency resource, or a time domain resource of the third time-frequency resource comprises a time domain resource of the fourth time-frequency resource, or
a frequency domain resource of the third time-frequency resource is the same as a frequency domain resource of the fourth time-frequency resource, and a time domain resource of the third time-frequency resource comprises a time domain resource of the fourth time-frequency resource.

13. The method according to claim 12, wherein in association with the frequency domain resource of the third time-frequency resource including the frequency domain resource of the fourth time-frequency resource, the frequency domain resource of the third time-frequency resource is the same as the frequency domain resource of the first time-frequency resource, the frequency domain resource of the fourth time-frequency resource is the same as the frequency domain resource of the second time-frequency resource, the first time-frequency resource is used to carry the first synchronization information, and the second time-frequency resource is used to carry the second synchronization information.

14. The method according to claim 1, wherein a transmission cycle of second information is different from a transmission cycle of third information in the first information, the second information includes the first synchronization information and/or the first broadcast information, and the third information includes the second synchronization information and/or the second broadcast information.

15. The method according to claim 13, further comprising:
sending configuration information indicating the transmission cycle of the second information and/or the transmission cycle of the third information.

16. The method according to claim 7, wherein a fifth time-frequency resource includes a sixth time-frequency resource, the fifth time-frequency resource is a time-frequency resource indicated by indication information in the first broadcast information and used by the first communication device for communication, and the sixth time-frequency resource is a time-frequency resource indicated by indication information in the second broadcast information and used by the second communication device for communication.

17. The method according to claim 16, wherein the fifth time-frequency resource includes the sixth time-frequency resource, and
a frequency domain resource of the fifth time-frequency resource includes a frequency domain resource of the sixth time-frequency resource, and a time domain resource of the fifth time-frequency resource is the same as a time domain resource of the sixth time-frequency resource, or a time domain resource of the fifth time-frequency resource comprises a time domain resource of the sixth time-frequency resource, or
a frequency domain resource of the fifth time-frequency resource is the same as a frequency domain resource of the sixth time-frequency resource, and a time domain resource of the fifth time-frequency resource includes a time domain resource of the sixth time-frequency resource.

18. The method according to claim 16, wherein in association with the frequency domain resource of the fifth time-frequency resource including the frequency domain resource of the sixth time-frequency resource, the frequency domain resource of the fifth time-frequency resource is the same as the frequency domain resource of the first time-frequency resource, the frequency domain resource of the sixth time-frequency resource is the same as the frequency domain resource of the second time-frequency resource, the first time-frequency resource is used to carry the first synchronization information, and the second time-frequency resource is used to carry the second synchronization information.

19. A cell synchronization method applied to a communication device or a chip in a communication device, wherein the communication device is a first communication device or a second communication device, the method comprising:
receiving first information including first synchronization information, wherein the first synchronization information is used by the first communication device to perform cell synchronization, second synchronization information in the first synchronization information is used by the second communication device to perform cell synchronization, and a type of the first communication device is different from a type of the second communication device; and
performing cell synchronization based on the first information.

20. A communication apparatus, comprising:
processing circuitry including at least one processor, wherein the processing circuitry is configured to:
determine first information including first synchronization information, wherein the first synchronization information is used by a first communication device to perform cell synchronization, second synchronization information in the first synchronization information is used by a second communication device to perform cell synchronization, and a type of the first communication device is different from a type of the second communication device; and
send the first information.
